(19) United States
(12) Patent Application Publication
(10) Pub. No.: US 2022/0123970 A1
(43) Pub. Date: Apr. 21, 2022

(54) RECEIVER FOR RECEIVING A COMBINATION SIGNAL TAKING INTO ACCOUNT INTER-SYMBOL INTERFERENCE, METHOD FOR RECEIVING A COMBINATION SIGNAL, AND COMPUTER PROGRAM

(71) Applicant: Innovationszentrum fuer Telekommunikationstechnik GmbH IZT, Erlangen (DE)

(72) Inventor: Martin HIRSCHBECK, Nuernberg (DE)

(21) Appl. No.: 17/566,172

(22) Filed: Dec. 30, 2021

Related U.S. Application Data
(63) Continuation of application No. PCT/EP2020/068877, filed on Jul. 3, 2020.

(30) Foreign Application Priority Data
Jul. 3, 2019 (DE) 102019209800.2

(51) Int. Cl. H04L 25/03

(52) U.S. Cl. CPC H04L 25/03331; H04L 25/03171

(57) ABSTRACT

A receiver for receiving a combination signal having two separate signal portions whose pulses are shifted relative to each other and/or whose carrier waves have a phase difference is configured to obtain a first series of samples using a first sampling, which is adjusted to a symbol phase of the first signal portion, and to obtain a second series of samples using a second sampling, which is adjusted to a symbol phase of the second signal portion, to obtain probabilities of transmission symbols of the first signal portion and probabilities of transmission symbols of the second signal portion for a plurality of sampling times based on the second and first series of samples, to determine probabilities for symbols of the second signal portion based on samples of the first sampling and estimated or calculated probabilities for symbols of the first signal portion, taking into account inter-symbol interference between transmission symbols of the second signal portion in the samples of the first sampling, and probabilities for symbols of the first signal portion based on samples of the second sampling and estimated or calculated probabilities for symbols of the second signal portion, taking into account inter-symbol interference between transmission symbols of the first signal portion in the samples of the second sampling.

### CROSS-REFERENCE TO RELATED APPLICATIONS

This application is a continuation of copending International Application No. PCT/EP2020/068877, filed Jul. 3, 2020, which is incorporated herein by reference in its entirety, and additionally claims priority from German Application No. 102019209800.2, filed Jul. 3, 2019, which is also incorporated herein by reference in its entirety.

### TECHNICAL FIELD

Embodiments according to the present invention relate to receivers for receiving a combination signal comprising two separate signal portions whose pulses are shifted to each other and/or whose carrier waves have a phase difference.

Further embodiments according to the invention relate to methods for receiving a combination signal.

Further embodiments according to the invention relate to corresponding computer programs.

Generally speaking, embodiments according to the invention relate to an optimization of a 2-user receiver.

### BACKGROUND OF THE INVENTION

In digital information transmission, it is often, or most often, the case that two or more similar, data-carrying message signals are additively superimposed on the transmission path or are already emitted as superimposed signals by a transmitter. As long as the signals can be separated on the transmission side by using a multiplex procedure, e.g. by using different frequency ranges (Frequency Division Multiplex: FDM), disjunct time slots (Time Division Multiplex: TDM), different codes (Code Division Multiplex Access: CDMA), or different spatial propagation directions and their resolution by several spatially separated receiving antennas (spatial multiplex or “Space-Division Multiple Access” by MIMO transmission: SDMA), this does not pose any problem and has been known since the beginning of electrical communications technology.

The situation becomes more complicated if the signals are superimposed simultaneously in the same frequency band in an uncoordinated manner. As long as the receive signals differ significantly with respect to the received power, the transmission rates (bits per symbol) and/or their power efficiency, successive demodulation, detection and decoding are often possible, i.e. detection of the respective strongest signal and its subtraction from the received sum signal after re-encoding and re-modulation on the basis of the detected data. Under certain boundary conditions, this procedure can even represent a solution which is optimal from the point of view of information theory.

It has been recognized that in the case of less pronounced differences in the received powers and/or power efficiencies of the individual signals, an iterative procedure may be advisable, wherein a partial subtraction of interfering signals, corresponding to the estimated probabilities of the data symbols, is performed, and the probabilities can be implemented in several iteration steps, in favor of a respective data symbol.

It has been shown that for signals of nearly equal intensity and equal power efficiency, only applying an optimal multi-user receiver (or at least an approximately optimal multi-user receiver) is usually a feasible approach. The superimposed signals are considered as one signal representing all data symbols corresponding to the superposition of the single signals, per modulation step. In the case of identical modulation methods for N individual signals, each with M signal elements per modulation step (M-step transmission method), this results in an equivalent modulation method for the receive side with up to M^{N} signal elements, wherein equal or very similar signal elements can sometimes be produced for different combinations of the individual data symbols in an unfavorable manner. This can cause a drastic loss of capacity.

An example to be mentioned here is the in-phase addition of two BPSK signals (M=N=2), wherein the constellation {−2; 0; +2} results from the superpositioning of two constellations {−1; +1} on the receiver side. A clear conclusion as to the transmission symbols when the receive symbol 0 is detected is no longer possible, even in the disturbance-free case. If inter-symbol interferences (ISI) occur in individual signals due to dispersive distortions (e.g., as a result of multipath propagation and/or reflections), an up to M^{NL}-step signal is generated for optimal multi-user detection, where L denotes the maximum length of inter-symbol interference, ISI, according to symbol intervals T. Generating the receive signal can be modulated by the mode of operation of a Mealy automatic machine with up to (M^{N})^{L-1} memory states.

It has been recognized that a common optimal detection of all the signals is possible by means of a trellis decoding method, advantageously the Viterbi or the BCJR algorithm, which is described, for example, in the book “Trellis-Codierung: Grundlagen and Anwendungen in der digitalen Übertragungstechnik”, Vol. 21 of Nachrichtentechnik” by J. Huber (Springer-Verlag, 1992).

It has also been recognized that the number of memory states becomes so large in most cases that a real-time implementation of a trellis decoder for optimal multi-user detection is no longer possible.

Therefore, there is need for an improved approach to multi-user communication providing an improved compromise between complexity and receive quality.

### SUMMARY

An embodiment may have a receiver for receiving a combination signal having two separate signal portions whose pulses are shifted relative to each other and/or whose carrier waves have a phase difference, wherein the receiver is configured to obtain a first series of samples using a first sampling, the first sampling being adjusted to a symbol phase of the first signal portion; wherein the receiver is configured to obtain a second series of samples using a second sampling, the second sampling being adjusted to a symbol phase of the second signal portion; wherein the receiver is configured to obtain probabilities of transmission symbols of the first signal portion and probabilities of transmission symbols of the second signal portion for a plurality of sampling times based on the first series of samples and the second series of samples; wherein the receiver is configured to determine probabilities for symbols of the second signal portion based on samples of the first sampling and estimated or calculated probabilities for symbols of the first signal portion taking into account inter-symbol interference between transmission symbols of the second signal portion in the samples of the first sampling; and wherein the receiver is configured to determine probabilities for symbols of the first signal portion based on samples of the second sampling and estimated or calculated probabilities for symbols of the second signal portion taking into account inter-symbol interference between transmission symbols of the first signal portion in the samples of the second sampling.

Another embodiment may have a method for receiving a combination signal having two separate signal portions whose pulses are shifted relative to each other and/or whose carrier waves have a phase difference, wherein the method has obtaining a first series of samples using a first sampling, the first sampling being adjusted to a symbol phase of the first signal portion; wherein the method has obtaining a second series of samples using a second sampling, the second sampling being adjusted to a symbol phase of the second signal portion; wherein the method has obtaining probabilities of transmission symbols of the first signal portion and probabilities of transmission symbols of the second signal portion for a plurality of sampling times based on the first series of samples and the second series of samples; wherein probabilities for symbols of the second signal portion are determined based on samples of the first sampling and estimated or calculated probabilities for symbols of the first signal portion taking into account inter-symbol interference between transmission symbols of the second signal portion in the samples of the first sampling; and wherein probabilities for symbols of the first signal portion are determined based on samples of the second sampling and estimated or calculated probabilities for symbols of the second signal portion taking into account inter-symbol interference between transmission symbols of the first signal portion in the samples of the second sampling.

Another embodiment may have a receiver for receiving a combination signal having two separate signal portions whose pulses are shifted relative to each other and/or whose carrier waves have a phase difference, wherein the receiver is configured to obtain a first series of samples using a first sampling, the first sampling being adjusted to a symbol phase of the first signal portion; wherein the receiver is configured to obtain a second series of samples using a second sampling, the second sampling being adjusted to a symbol phase of the second signal portion; wherein the receiver is configured to obtain probabilities of transmission symbols of the first signal portion and probabilities of transmission symbols of the second signal portion for a plurality of sampling times based on the first series of samples and the second series of samples; wherein the receiver is configured to determine probabilities for symbols of the second signal portion based on samples of the first sampling and estimated or calculated probabilities for symbols of the first signal portion taking into account inter-symbol interference between transmission symbols of the second signal portion in the samples of the first sampling; and wherein the receiver is configured to determine probabilities for symbols of the first signal portion based on samples of the second sampling and estimated or calculated probabilities for symbols of the second signal portion taking into account inter-symbol interference between transmission symbols of the first signal portion in the samples of the second sampling, wherein sampling times of the first sampling are set to sample an output signal of a signal-adjusted filter such that an output signal portion of the signal-adjusted filter which is based on the first signal portion is sampled substantially free of inter-symbol interference; and wherein sampling times of the second sampling are set to sample an output signal of a signal-adjusted filter such that an output signal portion of the signal-adjusted filter which is based on the second signal portion is sampled substantially free of inter-symbol interference.

Another embodiment may have a receiver for receiving a combination signal having two separate signal portions whose pulses are shifted relative to each other and/or whose carrier waves have a phase difference, wherein the receiver is configured to obtain a first series of samples using a first sampling, the first sampling being adjusted to a symbol phase of the first signal portion; wherein the receiver is configured to obtain a second series of samples using a second sampling, the second sampling being adjusted to a symbol phase of the second signal portion; wherein the receiver is configured to obtain probabilities of transmission symbols of the first signal portion and probabilities of transmission symbols of the second signal portion for a plurality of sampling times based on the first series of samples and the second series of samples; wherein the receiver is configured to determine probabilities for symbols of the second signal portion based on samples of the first sampling and estimated or calculated probabilities for symbols of the first signal portion taking into account inter-symbol interference between transmission symbols of the second signal portion in the samples of the first sampling; wherein the receiver is configured to determine probabilities for symbols of the first signal portion based on samples of the second sampling and estimated or calculated probabilities for symbols of the second signal portion taking into account inter-symbol interference between transmission symbols of the first signal portion in the samples of the second sampling wherein the receiver is configured to obtain first branch transition probabilities γ_{1,k} [i,j] according to

$${γ}_{1 , k} [ i , j ] = {\sum }_{m = 0}^{{M}_{1} - 1} {p}_{1 , m} [ k ] {e}^{- \frac{{\vert {y}_{1} [ k ] - ( {v}_{1} {α}_{1 , m} {e}^{j ( {φ}_{1} - {φ}_{2 )}} + {i}_{1 , p} ) \vert}^{2}}{{v}_{3}^{2}}}$$

wherein m is a control variable,

wherein M₁ is a number of constellation points of the first signal portion;

wherein p_{1,m}[k] are estimated or calculated probabilities of the respective transmission symbols of the first signal portion at a time step k;

wherein y₁[k] is a sample of the first sampling at a time step k;

wherein v₁ is a gain factor of the first signal portion;

wherein a_{1,m} is a transmission symbol of the first signal portion with transmission symbol index m, or

wherein a_{1,m} describes a contribution of a transmission symbol of the first signal portion with a transmission symbol index m to the sample y₁[k], which is a time-variable contribution a_{1,m}[k] in the case of a difference between a carrier frequency of the first signal portion and a carrier frequency of the second signal portion;

wherein φ₁-φ₂ describes a phase shift between transmission symbols of the first signal portion and transmission symbols of the second signal portion;

wherein i_{1,p} describes inter-symbol interference between transmission symbols of the second signal portion; and wherein v₃ describes a noise intensity;

and/or wherein the receiver is configured to obtain second branch transition probabilities γ_{2,k} [i,j] according to

$${γ}_{2 , k} [ i , j ] = {\sum }_{m = 0}^{{M}_{2} - 1} {p}_{2 , m} [ k ] {e}^{- \frac{{\vert {y}_{2} [ k ] - ( {v}_{2} {α}_{2 , m} {e}^{j ( {φ}_{2} - {φ}_{1 )}} + {i}_{2 , p} ) \vert}^{2}}{{v}_{3}^{2}}}$$

wherein m is a control variable,

wherein M₂ is a number of constellation points of the second signal portion;

wherein p_{2,m}[k] are estimated or calculated probabilities of the respective transmission symbols of the second signal portion at a time step k;

wherein y₂[k] is a sample of the second sampling at a time step k;

wherein v₂ is a gain factor of the second signal portion;

wherein a_{2,m} is a transmission symbol of the second signal portion with transmission symbol index m, or

wherein a_{2,m} describes a contribution of a transmission symbol of the first signal portion with a transmission symbol index m to the sample y₂[k], which is a time-variable contribution a_{2,m}[k] in the case of a difference between a carrier frequency of the first signal portion and a carrier frequency of the second signal portion;

wherein φ₂-φ₁ describes a phase shift between transmission symbols of the second signal portion and transmission symbols of the first signal portion;

wherein i_{2,p} describes inter-symbol interference between transmission symbols of the first signal portion; and

wherein v₃ describes a noise intensity.

Another embodiment may have a non-transitory digital storage medium having stored thereon a computer program for performing the above inventive methods for receiving a combination signal, when the program runs on a computer.

An embodiment according to the invention provides a receiver for receiving a combination signal comprising two separate signal portions whose pulses are shifted to each other and/or whose carrier waves have a phase difference.

For example (but not necessarily), the receiver comprises at least one filter adjusted (or matched) to a transmit pulse shape of the pulses of at least one of the signal portions.

The receiver is configured to obtain a first series of samples (e.g., y₁[k]) using first sampling, the first sampling being adjusted to a symbol phase of the first signal portion (e.g. synchronized to a symbol phase of the first signal portion).

The receiver is configured to obtain a second series of samples (e.g. y₂[k]) using second sampling, the second sampling being adjusted to a symbol phase of the second signal portion (e.g. synchronized to a symbol phase of the second signal portion).

The receiver is configured to obtain probabilities (e.g. p_{1,m}[k]) of transmission symbols of the first signal portion and probabilities (e.g. p_{2,m}[k]) of transmission symbols of the second signal portion for a plurality of sampling times (e.g. k) based on the first series of samples and the second series of samples.

The receiver is configured to determine probabilities (e.g. p_{2,m}[k]) for symbols (e.g. m=0 . . . M₂−1) of the second signal portion based on samples (e.g. y₁[k]) of the first sampling (e.g. of the sampling synchronized to the symbol clock of the first signal portion) and estimated or calculated probabilities (e.g. p_{1,m}[k]) for symbols (e.g. m=0 . . . M₁−1) of the first signal portion, taking into account inter-symbol interference (e.g. i_{1,p}) between transmission symbols of the second signal portion in the samples (e.g. y₁[k]) of the first sampling.

The receiver is configured to determine (for example updated) probabilities (e.g. p_{1,m}[k]) for symbols (e.g. m=0 . . . M₁−1) of the first signal portion based on samples (e.g. y₂[k]) of the second sampling (i.e., for example, of the sampling synchronized to the symbol clock of the second signal portion) and estimated or calculated probabilities, e.g. (p_{2,m}[k]) for symbols (e.g. m=0 . . . M₂−1) of the second signal portion, taking into account inter-symbol interference (e.g. i_{2,p}) between transmission symbols of the first signal portion in the samples (e.g. y₂[k]) of the second sampling.

The embodiment of the invention is based on the finding that a reception result can be improved, for example, by providing two series of samples in each of which, with respect to one of the signal portions, inter-symbol interference is significantly reduced or minimized or eliminated by synchronization to a respective symbol phase of the respective signal portion, and by taking into account the inter-symbol interference of the respective other signal portion when determining the probabilities of the symbols of the respective other signal portion.

In other words, by generating two separate series of samples, wherein in the first series of samples inter-symbol interference with respect to the first signal portion is reduced or minimized, and wherein in the second series of samples inter-symbol interference with respect to the second signal portion is reduced or minimized, “coupling” of the inter-symbol interferences of the two signal portions can be avoided on the one hand, thereby significantly reducing complexity. On the other hand, both the inter-symbol interference of the first signal portion and the inter-symbol interference of the second signal portion are taken into account, thus achieving a high receive quality while maintaining an acceptable complexity. In particular, knowledge of the specific characteristics of the inter-symbol interference of the first signal portion in the second series of samples and knowledge of the characteristics of the inter-symbol interference of the second signal portion in the first series of samples can thus be taken into account when separating the signal portions (i.e. when determining probabilities of transmission symbols of the first signal portion and when determining probabilities of transmission symbols of the second signal portion), typically resulting in a particularly good receive quality. In other words, the knowledge of the characteristics of inter-symbol interference of the signal portions, which is typically available at the receiver side, can be used in an efficient manner (without too much complexity) when separating the signal portions by the receiver by generating two series of samples, and by determining probabilities for symbols of the second signal portion based on the first series of samples using knowledge of characteristics of inter-symbol interference between transmission symbols of the second signal portion, and by determining probabilities for symbols of the first signal portion in the samples based on the second series of samples using receiver-side knowledge of characteristics of inter-symbol interference between transmission symbols of the first signal portion.

Thus, the receiver described here achieves a good compromise between receive quality and complexity, although the complexity in itself may be higher than in a receiver that only takes into account inter-symbol interference of one of the signal portions.

In one embodiment of the receiver, sampling times of the first sampling are set such that (or the receiver is configured to set sampling times of the first sampling, for example by selecting the associated symbol phase) such that sampling of an output signal of a signal-adjusted filter is performed such that an output signal portion of the signal-adjusted filter, which is based on the first signal portion is sampled essentially free of inter-symbol interference (for example by sampling with a symbol clock, a symbol phase being selected in such a way that the first signal portion is sampled “at the optimum times”, that is, for example, free of ISI, or for example in such a way that sampling times differ by at most 5% or at most 10% of a symbol phase or of a symbol duration from zero crossings of a response of the signal-adjusted filter to a single transmission symbol of the first signal portion).

Sampling times of the second sampling are, for example, set such that (or the receiver is configured to set sampling times of the second sampling, for example by selecting the associated symbol phase) such that sampling of an output signal of a signal-adjusted filter is performed such that an output signal portion of the signal-adjusted filter, which is based on the second signal portion is sampled essentially free of inter-symbol interference.

For example, by appropriately setting the sampling times of the first sampling and the second sampling, it may be achieved that it is no longer necessary to take into account inter-symbol interference between symbols of the first signal portion when evaluating the first series of sampling times. Similarly, by appropriately selecting the sampling times, it is no longer necessary to take into account inter-symbol interference between symbols of the second signal portion when evaluating the second series of samples. In particular, it is also achieved that knowledge of inter-symbol interference of the first signal portion and the second signal portion can be used separately, whereas, on the other hand, if only one series of samples were used, for example, which would neither be sampled free of inter-symbol interference with respect to the first signal portion nor free of inter-symbol interference with respect to the second signal portion, a very high complexity would result, since the inter-symbol interferences would then have to be considered in combination.

Moreover, with regard to the separation of the two signal portions, the corresponding procedure makes allows applying a concept in which the two signal portions are processed “equally”. This simplifies the algorithm and also results in particularly good results.

In one embodiment, the receiver is configured to adjust (or, for example, synchronize to) the first sampling to the symbol phase of the first signal portion and to the carrier phase of the second signal portion.

The receiver is further configured to adjust (or, for example, synchronize to) the second sampling to the symbol phase of the second signal portion and to the carrier phase of the first signal portion.

By this implementation, it can be achieved that inter-symbol interference with respect to the first signal portion is reduced or, ideally, completely suppressed in the first series of samples. Furthermore, it is also achieved by the corresponding implementation that inter-symbol interference with respect to the second signal portion is significantly reduced or, ideally, completely suppressed in the second series of samples. By adjusting the first sample to the carrier phase of the second signal portion and by adjusting the second sample to the carrier phase of the first signal portion, it can further be achieved that the samples are particularly easy to process, for example ideally separated according to in-phase component and quadrature component.

In one embodiment, the receiver is configured to determine first branch transition probabilities (e.g. γ_{1,k} [i,j]) between states of a first state model (e.g. between memory states of a first discrete-time filter or a hidden Markov model) describing inter-symbol interference between transmission symbols of the second signal portion in the samples of the first sampling, based on the samples (e.g. y₁[k]) of the first sampling and estimated or calculated probabilities (e.g. p_{1,m}[k]) for symbols (e.g. m=0 . . . M₁−1) of the first signal portion, and to determine, based on the first branch transition probabilities (e.g. γ_{1,k}[i,j]), probabilities (e.g. p_{2,m} [k]) for symbols (e.g. m=0 . . . M₂−1) of the second signal portion.

Alternatively or additionally, the receiver is configured to determine second branch transition probabilities (e.g. γ_{2,k}[i,j]) between states of a second state model (e.g. between memory states of a discrete-time filter or a hidden Markov model) describing inter-symbol interference between transmission symbols of the first signal portion in the samples of the second sampling, based on the samples (e.g. y₂[k]) of the second sampling and estimated or calculated probabilities (e.g., p_{2,m}[k]) for symbols (e.g. m=0 . . . M₂−1) of the second signal portion, and to determine, based on the second branch transition probabilities (e.g. γ_{2,k}[i,j]), probabilities (e.g. p_{1,m}[k]) for symbols (e.g. m=0 . . . M₁−1) of the first signal portion.

By evaluating, using the samples of the first sampling in which inter-symbol interference between transmission symbols of the first signal portion is reduced or suppressed, an inter-symbol interference of the second signal portion using a state model (having, for example, information on a characteristic of the inter-symbol interference), and by evaluating, using the second sampling in which inter-symbol interference between symbols of the second signal portion is reduced or suppressed, inter-symbol interference between transmitted symbols of the first signal portion using a state model having, for example, information on the inter-symbol interference, a probability of transmission symbols of the two signal portions can be determined in a very reliable manner, for example. Thus, information on inter-symbol interference characteristics of the first signal portion as well as on inter-symbol interference characteristics of the second signal portion are used here, avoiding excessive complexity that would arise, for example, if both inter-symbol interferences were taken into account simultaneously, by determining two sequences of samples. Thus, the available information (in particular the information on inter-symbol interference characteristics included in the state models) can be used to separate the two signal portions without complexity becoming too high.

In one embodiment, the receiver is configured to obtain the probabilities for symbols of the second signal portion using a first probability density function (e.g.

$${\sum }_{m = 0}^{{M}_{1} - 1} {p}_{1 , m} [ k ] {e}^{- \frac{{\vert {y}_{1} [ k ] - ( {v}_{1} {α}_{1 , m} {e}^{j ( {φ}_{1} - {φ}_{2 )}} + {i}_{1 , p} ) \vert}^{2}}{{v}_{3}^{2}}}$$

of a disturbance affecting a detection of transmission symbols of the second signal portion, wherein the first probability density function takes into account a probability (e.g. p_{1,m}[k]) of at least one transmission symbol of the first signal portion (for example in the form of weighting), an expected contribution (e.g. v₁ a_{1,m}, e^{i(φ1-φ2)} of at least one transmission symbol of the first signal portion to a sample of the first sampling (for example, taking into account a phase shift between signal portions of the first signal and signal portions of the second signal), and

an expected contribution (e.g. i_{1,p}) of inter-symbol interference between transmission symbols of the second signal portion (associated, for example, to a state transition for which a branch transition probability is determined) (e.g. in the first sampling), (wherein the first probability density function is used, for example, to determine the first branch transition probability).

For example, by evaluating a probability density function which describes a sum of probabilities for different possible transmission symbols of the first signal portion, weighted by the respective probabilities, and which simultaneously describes inter-symbol interference values between transmission symbols of the second signal portion for a currently considered state transition (e.g. i,j), a (local) probability for a state transition of the second signal portion (e.g. a probability that the second signal portion has a particular symbol sequence while taking into account only a single sample) may be determined, for example. Thus, the available information can be taken into account quite comprehensively. On the one hand, probabilities of different possible transmission symbols of the first signal portion are taken into account, and on the other hand, for example, inter-symbol interference contributions between transmission symbols of the second signal portion for different sampling times of the second signal portion can also be taken into account. Thus, all in all, by evaluating the probability distribution (which may be obtained, for example, from a superposition of different probability density functions), branch transition probabilities may be obtained which may be used, for example, to determine probabilities of transmission symbols of the second signal portion.

In one embodiment, the receiver is configured to take into account, when evaluating the first probability density function, a time-varying contribution of a transmission symbol of the first signal portion which results due to a difference in carrier frequencies of the first signal portion and the second signal portion.

By the corresponding procedure, for example, a deviation of carrier frequencies between the first signal portion and the second signal portion can be taken into account in an efficient manner. The contribution of transmission symbols of the first signal portion can be weighted in a time-variable manner, for example by multiplying it by a time-variable complex pointer. Thus, different signal portions are detectable without major problems even if the carrier frequencies differ somewhat.

In one embodiment, the receiver is configured to obtain the probabilities for symbols of the first signal portion using a second probability density function

$${\sum }_{m = 0}^{{M}_{2} - 1} {p}_{2 , m} [ k ] {e}^{- \frac{{\vert {y}_{2} [ k ] - ( {v}_{2} {α}_{2 , m} {e}^{j ( {φ}_{2} - {φ}_{1 )}} + {i}_{2 , p} ) \vert}^{2}}{{v}_{3}^{2}}} )$$

(e.g. of a disturbance affecting a detection of transmission symbols of the first signal portion, wherein the second probability density function takes into account
a probability (e.g. p_{2,m}[k]) of at least one transmission symbol of the second signal portion (for example in the form of weighting)
an expected contribution (e.g. v₂ a_{2,m} e^{i(φ2-φ1)}) of at least one transmission symbol of the second signal portion to a sample of the second sampling (for example, taking into account a phase shift between signal portions of the first signal and signal portions of the second signal), and

an expected contribution (e.g. i_{2,p}) of an inter-symbol interference between transmission symbols of the first signal portion (which is, for example, associated to a state transition for which a branch transition probability is determined) (e.g. in the second sampling), (where the second probability density function is used, for example, to determine the second branch transition probability).

For example, by obtaining probabilities for symbols of the first signal portion in an analogous manner to the probabilities for symbols of the second signal portion, an equally high reliability in estimating symbols of both signal portions can be achieved. Knowledge of inter-symbol interference may also be used with respect to determining both signal portions without introducing excessive complexity.

In one embodiment, the receiver is configured to take into account, when evaluating the second probability density function, a time-varying contribution of a transmission symbol of the second signal portion which results due to a difference in carrier frequencies of the first signal portion and the second signal portion.

By the corresponding procedure, a difference of carrier frequencies of the two signal portions can again be taken into account in a very simple and efficient way.

In one embodiment, the receiver is configured to obtain, based on the first branch transition probabilities (e.g. γ_{1,k}[i,j]) (e.g. using a trellis decoding method or using the Bahl, Cocke, Jelinek, and Raviv (BCJR) algorithm), first state transition probabilities (e.g. p_{1,k}(i,j)) and to determine probabilites (e.g., p_{2,m}[k]) for symbols (e.g., m=0 . . . M₂−1) of the second signal portion using the first state transition probabilities (e.g. p_{1,k}(i,j)). Alternatively or additionally, the receiver is configured to obtain, based on the second branch transition probabilities (e.g. γ_{2,k}[i,j]) (e.g., using a trellis decoding method or using the Bahl, Cocke, Jelinek, and Raviv (BCJR) algorithm), second state transition probabilities (e.g. p_{2,k}(i,j) and to determine probabilities (e.g. p_{1,m}[k]) for symbols (e.g. m=0 . . . M₁−1) of the first signal portion using the second state transition probabilities (e.g. p_{2,k}(i,j)).

By using the corresponding algorithms, the information on the inter-symbol interference between symbols of the first signal portion and also the knowledge on the inter-symbol interference between symbols of the second signal portion can be exploited in an efficient manner, and symbol probabilities can be obtained by said methods or algorithms at reasonable complexity.

In one embodiment, the receiver is configured to determine first branch transition probabilities (e.g. γ_{1,k}[i,j]) (e.g. associated to a transmission symbol of the second signal portion or a state transition from state i to state j based on a transmission symbol of the second signal portion) based on a sum of probability contributions for different possible transmission symbols (e.g. m=0 to M₁−1) of the first signal portion.

The probability contributions are weighted according to the estimated or calculated probabilities (e.g. p_{1,m}[k]) of the respective (e.g. associated) transmission symbols of the first signal portion and describe a probability that a predetermined transmission symbol of the second signal portion follows a predetermined sequence of transmission symbols of the second signal portion (determined, for example, by the state transition from state i to state j), taking into account a current sample (e.g. y₁[k]) of the first sampling, an inter-symbol interference (e.g. i_{1,p}) between transmission symbols of the second signal portion and a noise intensity (e.g. v₃). Alternatively or additionally, the receiver is configured to determine second branch transition probabilities (e.g. γ_{2,k}[i,j]) (e.g., associated to a transmission symbol of the first signal portion or a state transition from state i to state j due to a transmission symbol of the first signal portion) based on a sum of probability contributions for different possible transmission symbols (e.g. m=0 to M₂−1) of the second signal portion, the probability contributions being weighted corresponding to the estimated or calculated probabilities (e.g. p_{2,m}[k]) of the respective (e.g. associated) transmission symbols of the second signal portion and describe a probability that a predetermined transmission symbol of the first signal portion follows a predetermined sequence of transmission symbols of the first signal portion (determined, for example, by the state transition from state i to state j), taking into account a current sample (e.g. y₂[k]) of the second sampling, an inter-symbol interference (e.g. i_{2,p}) between transmission symbols of the first signal portion and a noise intensity (e.g. v₃).

By the corresponding procedure, the uncertainty of the respective transmission symbols or the predetermined or estimated probabilities of the respective transmission symbols can be taken into account. Similarly, inter-symbol interference can be efficiently taken into account in this way, wherein only the inter-symbol interference between transmission symbols of a signal portion are taken into account in each step or sub-step. For example, when determining probabilities of transmission symbols of the second signal portion, the predetermined or estimated probability of transmission symbols of the first signal portion is taken into account. Furthermore, when determining probabilities of a transmission symbol of the second signal portion, the influence of different sequences of transmission symbols of the second signal portion on a current sample of the first sample due to inter-symbol interference is taken into account. Thus, for example, so-called “branch transition probabilities”are determined, which are finally used to infer the probabilities of transmission symbols of the second signal portion. A corresponding concept can also be used for estimating probabilities of transmission symbols of the first signal portion and thus enables efficiently and reliably determining probabilities of transmission symbols of both signal portions.

In one embodiment, the receiver is configured to estimate transmission symbols of the second transmit signal portion based on a selection of state transitions. The receiver is configured to select the state transitions to maximize an overall transition probability which is based on the branch transition probabilities. Alternatively or additionally, the receiver is configured to estimate transmission symbols of the first transmit signal portion based on a selection of state transitions, wherein the receiver is configured to select the state transitions to maximize an overall transition probability which is based on the branch transition probabilities.

By maximizing an overall transition probability, transmission symbols of the first signal portion and/or the second signal portion are reliably estimated or assessed with respect to their probability. By identifying a “best” sequence of state transitions, a reliable determination of probabilities of transmission symbols of the first signal portion and/or the second signal portion is possible.

In one embodiment, the receiver is configured to obtain first branch transition probabilities γ_{1,k}[i,j] according to

$${γ}_{1 , k} [ i , j ] = {\sum }_{m = 0}^{{M}_{1} - 1} {p}_{1 , m} [ k ] {e}^{- \frac{{\vert {y}_{1} [ k ] - ( {v}_{1} {α}_{1 , m} {e}^{j ( {φ}_{1} - {φ}_{2 )}} + {i}_{1 , p} ) \vert}^{2}}{{v}_{3}^{2}}}$$

wherein m is a control variable, wherein M₁ is a number of constellation points (e.g. of different possible transmission symbols) of the first signal portion, wherein p_{1,m}[k] are estimated or calculated probabilities of the respective (e.g. associated) transmission symbols of the first signal portion at a time step k, wherein y₁[k] is a sample of the first sampling at a time step k, wherein v₁ is a gain factor of the first signal portion, wherein a_{1,m} is a (for example complex-valued) transmission symbol (for example represented by a constellation point) of the first signal portion with transmission symbol index (or constellation point index) m, or wherein a_{1,m} describes a time-variable contribution of a transmission symbol of the first signal portion with a transmission symbol index m to the sample y₁[k] which results due to a difference between a carrier frequency of the first signal portion and a carrier frequency of the second signal portion (i.e. is defined, for example, according to a_{1,m}[k] according to equation (3.10)), wherein φ₁-φ₂ describes a phase shift between transmission symbols of the first signal portion and transmission symbols of the second signal portion, wherein i_{1,p} describes an inter-symbol interference between transmission symbols of the second signal portion (which is associated to a state transition i,j, for example), and wherein v₃ describes a noise intensity.

Alternatively or additionally, the receiver is configured to obtain second branch transition probabilities γ_{2,k}[i,j] according to

$${γ}_{2 , k} [ i , j ] = {\sum }_{m = 0}^{{M}_{2} - 1} {p}_{2 , m} [ k ] {e}^{- \frac{{\vert {y}_{2} [ k ] - ( {v}_{2} {α}_{2 , m} {e}^{j ( {φ}_{2} - {φ}_{1 )}} + {i}_{2 , p} ) \vert}^{2}}{{v}_{3}^{2}}}$$

wherein m is a control variable, wherein M₂ is a number of constellation points (e.g. of different possible transmission symbols) of the second signal portion, wherein p_{2,m}[k] are estimated or calculated probabilities of the respective (e.g. associated) transmission symbols of the second signal portion (e.g. with transmission symbol index m) at a time step k, wherein y₂[k] is a sample of the second sampling at a time step k, wherein v₂ is a gain factor of the second signal portion, wherein a_{2,m} is a (for example complex-valued) transmission symbol (for example represented by a constellation point) of the second signal portion with transmission symbol index (or constellation point index) m, or wherein a_{2,m} describes a time-variable contribution of a transmission symbol of the second signal portion with a transmission symbol index m to the sample y₂[k] which results due to a difference between a carrier frequency of the first signal portion and a carrier frequency of the second signal portion (i.e. is defined, for example, according to a_{2,m}[k] according to equation (3.11)), wherein φ₂-φ₁ describes a phase shift between transmission symbols of the second signal portion and transmission symbols of the first signal portion, wherein i_{2,p} describes an inter-symbol interference between transmission symbols of the first signal portion (which is associated to a state transition i,j, for example), and wherein v₃ describes a noise intensity.

It has been recognized that such a determination of branch transition probabilities very effective is on the one hand and leads to reliable results on the other hand. In particular, it was recognized that the input variables available for calculating the branch transition probabilities can also be determined in a simple manner. For example, the probabilities of the transmission symbols of the respective other signal portion can either be estimated in advance or set to a predetermined initial value at the beginning of an iteration, for example, or determined as part of an iterative procedure in a previous step. The intensity of the respective signal portions which is included in the gain factor v may also be determined, for example in view of an overall power of the signal and using a comparison of the samples of the first sampling and the second sampling. The phase offset between the first signal portion and the second signal portion can be determined, for example, in the context of setting the first sampling and the second sampling. For example, the inter-symbol interference between transmission symbols of a signal portion can be determined based on knowing at which times sampling is performed and further based on a knowledge of a transmit waveform of a single transmission symbol. For example, the inter-symbol interference for different sequences of transmission symbols can be predetermined once corresponding sampling times or the phase shifts between the transmission symbols of both signal portions are known. Also, the noise intensity can be estimated by means of conventional estimation methods. In this respect, the above equations for determining the branch transition probabilities can be evaluated with comparatively moderate effort and take into account the inter-symbol interference in a precise manner.

Thus, all in all, a reliable result can be obtained using the above formula.

In one embodiment, the receiver is configured to determine, based on the first branch transition probabilities γ_{1,k}[i,j], using forward recursion (e.g. based on initial probabilities, e.g. at an initial sampling time of the plurality of sampling times), probabilities α_{1,k,1,k}[i] for a state l in a k-th time step (e.g. first forward state probabilities) (wherein the probabilities α_{1,k,1,k}[i], for example, describe the probability of a memory state of the discrete filter at a sampling time, starting from an initial sampling time of the plurality of sampling times). The receiver is further configured to determine, based on the first branch transition probabilities. γ_{1,k}[i,j], using backward recursion (for example starting from final probabilities, for example, at a final sampling time of the plurality of sampling times), probabilities β_{1,k+1}[j] for a state j in a k+1-th time step (for example, first backward state probabilities) (wherein the probabilities β_{1,k+1}[j] describe, for example, the probability of a memory state of the discrete filter at a sampling time, based on a final sampling time of the plurality of sampling times). The receiver is further configured to determine first state transition probabilities (p_{1,k}i,j)) based on the probabilities α_{1,k}[i] for a state i in a k-th time step (e.g. the first forward state probabilities) and β_{1,k+1}[j] for a state j in a k+1-th time step (e.g. the first backward state probabilities) and using the first branch transition probabilities, and to obtain probabilities (e.g. p_{2,m}[k]) of transmission symbols of the second signal portion based on the first state transition probabilities (e.g. p_{1,k}(i,j)).

Alternatively or additionally, the receiver is configured to determine, based on the second branch transition probabilities γ_{2,k}[i,j] using forward recursion (for example, starting from initial probabilities), probabilities α_{2,k}[i] for a state i in a k-th time step (for example, second forward state probabilities) (wherein the probabilities α_{2,k}[i] describe, for example, the probability of a memory state of the discrete filter at a sampling time, starting from an initial sampling time of the plurality of sampling times). In this case, the receiver is further configured to determine, based on the second branch transition probabilities γ_{2,k}[i,j] using backward recursion (for example, starting from final probabilities, for example, at a final sampling time of the plurality of sampling times), probabilities β_{2,k+1}[j] for a state j in a k+1-th time step (for example, second backward state probabilities) (wherein the probabilities β_{2,k+1}[j] describe, for example, the probability of a memory state of the discrete filter at a sampling time, starting from a final sampling time of the plurality of sampling times). The receiver is then further configured to determine, based on the probabilities α_{2,k}[i] for a state i in a k-th time step (for example, the second forward state probabilities) and β_{2,k+1}[j] for a state j in a k+1-th time step (for example, the second backward state probabilities) and using the first branch transition probabilities, second state transition probabilities (p_{2,k}(i,j)), and to obtain probabilities (p_{1,m}[k]) of transmission symbols of the first signal portion based on the second state transition probabilities.

By determining state probabilities based on the branch transition probabilities, the probabilities of transmission symbols of a respective signal portion considered can be inferred in an efficient manner. The use of forward recursion and backward recursion here can help to obtain the probabilities of transmission symbols of the respective signal portion in an efficient and reliable manner.

In one embodiment, the receiver is configured to obtain the first state transition probabilities p_{1,k}(i,j) according to

p_{1,k}(i,j)=c_{trans,k}α_{1,k}[i]γ_{1,k}[i,j]β_{1,k+1}[j]

wherein c_{trans,k} is a normalization factor.

Alternatively or additionally, the receiver is configured to obtain the second state transition probabilities p_{2,k}(i,j) according to

p_{2,k}(i,j)=c_{trans,k}α_{2,k}[i]γ_{2,k}[i,j]β_{2,k+1}[j]

wherein c_{trans,k} is a normalization factor.

The access transition probabilities can be calculated easily by the said calculation, based on the state probabilities and the branch transition probabilities.

In one embodiment, the receiver is configured to obtain probabilities (e.g. p_{2,m}[k]) of transmission symbols of the second signal portion for a plurality of sampling times (e.g. k) based on the first series of samples (e.g. MD, thereby taking into account inter-symbol interference (e.g. i_{1,p}) between transmission symbols of the second signal portion in the first series of samples by using a first instance of a BCJR method and taking into account superposition (e.g. v₁a_{1,m}e^{j(φ1-φ2)}) by transmission symbols of the first signal portion as disturbance.

The receiver is further configured to obtain probabilities (e.g. p_{1,m}[k]) of transmission symbols of the first signal portion for a plurality of sampling times (e.g. k) based on the second series of samples (e.g. y₂[k]), thereby taking into account inter-symbol interference (e.g. i_{2,p}) between transmission symbols of the first signal portion in the second series of samples by using a second instance of a BCJR method (e.g. performed separately from the first instance of the BCJR method) and taking into account superposition (e.g. v₂a_{2,m},ej^{(φ2-φ1)}) by transmission symbols of the second signal portion as disturbance.

It has been shown that by using two instances of the BCJR method, for example performed separately, or performed sequentially, or performed in an iterative or alternating manner, the probabilities of the transmission symbols of the two signal portions can be determined in an efficient and reliable manner. By taking into account superposition by transmission symbols of the respective other signal portion as disturbance, wherein, for example, inter-symbol interference with respect to the transmission symbols of the respective other signal portion is disregarded, a very high efficiency of the algorithm can be achieved or excessive complexity can be avoided. Thus, in the context of an instance of the BCJR method, only inter-symbol interference of a respective signal portion considered is dealt with, while superposition of the transmission symbols of the respective other signal portion is merely included as “disturbance” without taking into account inter-symbol interference in this respect. Thus, the concept described here represents a very good compromise in terms of complexity and reliability.

In one embodiment, the receiver is configured to determine transmission symbols underlying the first signal portion, or probabilities of transmission symbols underlying the first signal portion, by means of a trellis decoding method or based on the Bahl, Cocke, Jelinek, and Raviv algorithm (BCJR algorithm).

The receiver is further configured to determine transmission symbols underlying the second signal portion, or probabilities of transmission symbols underlying the second signal portion, by means of a trellis decoding method or based on the Bahl, Cocke, Jelinek, and Raviv algorithm (BCJR algorithm).

By determining transmission symbols, or probabilities of transmission symbols, by means of a trellis decoding method or an Bahl, Cocke, Jelinek and Raviv algorithm, the inter-symbol interference in one of the signal portions can be taken into account in an efficient manner. In particular, by using the algorithms mentioned, knowledge of the receiver with respect to the inter-symbol interference can also be exploited, resulting in an improved reliability of the estimated transmitted symbols or estimated probabilities of transmission symbols.

One embodiment provides a method for receiving a combination signal having two separate signal portions whose pulses are shifted relative to each other and/or whose carrier waves have a phase difference.

The method comprises obtaining a first series of samples (y₁[k]) using a first sampling, the first sampling being adjusted to a symbol phase of the first signal portion (for example synchronized to a symbol phase of the first signal portion).

The method comprises obtaining a second series of samples (y₂[k]) using a second sampling, the second sample being adjusted to a symbol phase of the second signal portion (for example synchronized to a symbol phase of the second signal portion).

The method comprises obtaining probabilities (e.g. p_{1,m}[k]) of transmission symbols of the first signal portion and probabilities (e.g. p_{2,m}[k]) of transmission symbols of the second signal portion for a plurality of sampling times (e.g. k) based on the first series of samples and the second series of samples,

wherein probabilities (e.g. p_{2,m}[k]) for symbols (e.g. m=0 . . . M₂−1) of the second signal portion are determined based on samples (e.g. y₁[k]) of the first sampling (i.e. the sampling synchronized to the symbol clock of the first signal portion) and estimated or calculated probabilities (e.g. p_{1,m}[k]) for symbols (e.g. m=0 . . . M₁−1) of the first signal portion, taking into account inter-symbol interference (e.g. i_{1,p}) between transmission symbols of the second signal portion in the samples (e.g. y₁[k]) of the first sampling, and wherein (e.g. updated) probabilities (e.g. p_{1,m} [k]) for symbols (e.g. m=0 . . . M₁−1) of the first signal portion are determined based on samples (e.g. y₂[k]) of the first signal portion (i.e. the sampling synchronized to the symbol clock of the second signal portion) and estimated or calculated probabilities (e.g. p_{2,m}[k]) for symbols (e.g. m=0 . . . M₂−1) of the second signal portion, taking into account inter-symbol interference (e.g. i_{2,p}) between transmission symbols of the first signal portion in the samples (e.g. y₂[k]) of the second sampling.

The corresponding method is based on the same considerations as the device described above. The method may additionally be supplemented by all the features, functionalities and details described herein also with respect to the devices according to the invention, both individually and in combination.

Another embodiment provides a computer program having program code for performing the method when the program runs on a computer. The computer program is based on the same considerations as the corresponding method and may also be supplemented by all the features, functionalities and details described herein, both individually and in combination.

### BRIEF DESCRIPTION OF THE DRAWINGS

Embodiments according to the present invention will be explained in more detail below with reference to the accompanying figures, in which:

FIG. 1 shows block diagram of a receiver according to an embodiment of the present invention;

FIGS. 2a, 2b show a flowchart of a concept for determining probabilities of transmission symbols of two signal portions according to an embodiment of the present invention;

FIG. 3 shows a block diagram of a receiver according to a further embodiment of the present invention;

FIGS. 4a, 4b show a flowchart of a concept for determining probabilities for symbols of two signal portions according to an embodiment of the present invention;

FIG. 5 shows a flowchart of a method according to an embodiment of the present invention;

FIG. 6 shows a flowchart of a method according to an embodiment of the present invention;

FIGS. 7a, 7b show a schematic representation of two different 2-user receiver concepts.

### DETAILED DESCRIPTION OF THE INVENTION

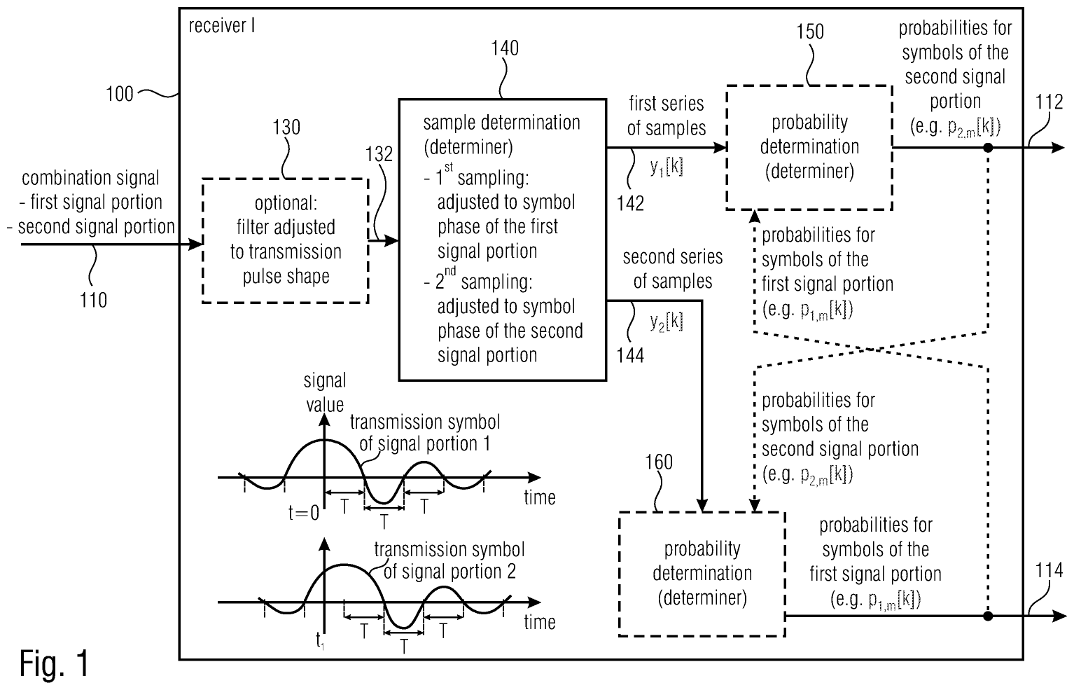

### 1. Receiver According to FIG. 1

FIG. 1 shows a block diagram of a receiver according to an embodiment of the present invention. The receiver according to FIG. 1 in its entirety is designated by 100.

The receiver 100 is configured to receive a combination signal 110 and, based thereon, to provide information 112 on probabilities for symbols of the second signal portion and information 114 on probabilities for symbols of the first signal portion.

It is assumed, for example, that the combination signal 110 comprises two separate signal portions whose pulses are shifted relative to each other and/or whose carrier waves have a phase difference. The two signal portions contained in the combination signal 110 may, for example, originate from different transmitters which transmit simultaneously, for example, i.e. without using a time-division multiplex or frequency-division multiplex or code-division multiplex, in an equal or overlapping frequency range.

The receiver 100 optionally includes a filter 130 adjusted to a transmission pulse shape, which exemplarity receives the combination signal 110 and provides a filtered version 132 of the combination signal 110. However, the filter 130 may be omitted such that the combination signal 110 takes the place of the filtered version 132 of the combination signal.

The receiver 100 further comprises a sample determination or sample determiner 140 configured to obtain a first series 142 of samples using a first sampling, wherein the first sampling is adjusted to a symbol phase of the first signal portion. The sample determination or sample determiner 140 is further configured to obtain a second series 144 of samples using a second sampling, wherein the second sampling is adjusted to a symbol phase of the second signal portion. For this purpose, the sample determiner 140 receives, for example, the combination signal 110 or the filtered version 132 of the combination signal. However, the sample determiner 140 may optionally receive a further pre-processed version of the combination signal 110. Such optional preprocessing may include, for example, filtering or frequency conversion, or any other type of preprocessing typically used in a receiver input stage.

In this regard, it should be noted that an input signal of the sample determination 140 or the sampling determiner 140 (which may comprise, for example, two analog-to-digital converters operating in a time offset, the sampling times of which are set or regulated correspondingly) may comprise, for example, two superimposed signal portions which are shifted in time relative to each other, of which, for example, a first signal portion can be sampled in a first time frame without inter-symbol interference, and of which, for example, a second signal portion can be sampled in a second time frame which is shifted in time relative to the first time frame without inter-symbol interference. For example, a waveform of the first signal portion associated with a transmission symbol may have a maximum at a time t=0 and then zeros at times T, 2T, 3T. For example, the first signal portion may consist of corresponding waveforms each shifted by T. Here, it is apparent that at times T, 2T, 3T, etc., only a respective portion of a single transmission symbol of the first signal portion contributes to the sample.

Similarly, for example, a waveform of the second signal portion associated with a transmission symbol may have a maximum at a time t and may have zeros at times t₁+T, t₁+2T, t₁+3T. Thus, if the second signal portion is sampled at times t₁, t₁+T, t₁+2T, t₁+3T, etc., corresponding samples each comprise only a contribution of a single transmission symbol of the second signal portion.

If it is now assumed that the first signal portion and the second signal portion, for example many transmission symbols of the first signal portion (time-shifted by integral multiples of T) and many transmission symbols of the second signal portion (also time-shifted by integral multiples of T, but time-shifted with respect to the transmission symbols of the first signal portion), are contained in superimposed form in the input signal of the sample determination 140, it will be apparent that a mixture of signals is produced here which is difficult to separate. It will also be apparent that, for example, when sampled at time t=0 (or at times t=k·T), a sample has, for example, a contribution from only a single transmission symbol of the first signal portion but contributions from several transmission symbols of the second signal portion. Similarly, a sample sampled at time t₁ (or at times t=t₁+k·T) has a contribution from only a single transmission symbol of the second signal portion but also contributions from multiple transmission symbols of the first signal portion (inter-symbol interference).

The sampling determination 140 is thus configured to obtain a first series 142 of samples using a first sampling, wherein the first sampling is adjusted to a symbol phase of the first signal portion. For example, the first sampling is performed at times t=0+k·T such that the first signal portion is sampled at least substantially free of inter-symbol interference, and such that the second signal portion is sampled with inter-symbol interference (such that, for example, only a single transmission symbol of the first signal portion has a (significant or non-negligible) influence on one of the samples and such that several transmission symbols of the second signal portion have a (significant or non-negligible) influence on the sample value).

The sample determination 140 is further configured, for example, to obtain a second series 144 of samples using a second sampling, wherein the second sampling is adjusted to a symbol phase of the second signal portion. For example, the second sampling may be performed at times t=t₁+k·T (wherein k is a natural number). Thus, for example, the second signal portion is sampled at least substantially free of inter-symbol interference, whereas, in contrast, the first signal portion is sampled subject to inter-symbol interference. For example, a sample is influenced (or substantially influenced) by a single transmission symbol of the second signal portion but by several transmission symbols of the first signal portion.

It should be noted, however, that the first sampling and the second sampling need not necessarily occur in an ideal manner. Rather, tolerances are possible with respect to the sampling times, which may be, for example, +/−5% or +/−10% or +/−20% of a sampling period T. Thus, for example, the first sampling may be at least approximately free of inter-symbol interference with respect to the first signal portion, whereas there may be (non-negligible) inter-symbol interference with respect to the second signal portion. For example, the inter-symbol interference in sampling may be negligible with respect to the first signal portion, for example such that the inter-symbol interference with respect to the first sample is less than 5% or less than 10% or less than 20% of a signal value caused by a current transmission symbol. The same may apply with respect to the second sample.

Moreover, it should be noted that corresponding sampling times can be set or adjusted, for example, by analyzing the combination signal 110. A phase shift, which will be referred to as φ₁-φ₂ or φ₂-φ₁ in the following, can also be determined.

The receiver 100 further comprises a first probability determination or first probability determiner 150 configured to obtain the first series 142 of samples and, based thereon, to obtain probabilities 112 for symbols of the second signal portion. The receiver 100 further comprises a second probability determination or second probability determiner 160 configured to obtain the second series 144 of samples and to determine probabilities 114 for symbols of the first signal portion based thereon. All in all, the receiver is thus configured to obtain probabilities of transmission symbols of the first signal portion and probabilities of transmission symbols of the second signal portion for a plurality of sampling times (for example denoted by k) based on the first series 142 of samples and the second series 144 of samples.

For example, the first probability determination 150 is configured to determine the probabilities 112 for symbols of the second signal portion based on samples of the first sample, that is based on samples of the first series 142 of samples, and estimated or calculated probabilities for symbols of the first signal portion, taking into account inter-symbol interference between transmission symbols of the second signal portion in the samples of the first sample (or the first series 142 of samples).

Further, the second probability determination 160 is configured, for example, to determine probabilities 114 for symbols of the first signal portion based on samples of the second sampling (i.e. based on the samples of the second series 144 of samples) and estimated or calculated probabilities for symbols of the second signal portion, taking into account inter-symbol interference between transmission symbols of the first signal portion in the samples of the second sample (i.e. in the samples of the second series 144 of samples).

For example, the first probability determination can obtain information on probabilities for symbols or transmission symbols of the first signal portion in various ways. For example, the probabilities of the symbols or transmission symbols of the first signal portion may be formed by default values, e.g. at the beginning of an evaluation, when no additional information are yet available on the receiver side. However, the probabilities of the symbols or transmission symbols of the first signal portion may also be provided by the second probability determination 160 if, for example, this has already been performed when the first probability determination takes place. Similarly, the information on probabilities for symbols or transmission symbols of the second signal portion, used by the second probability determination 160 may be based on predetermined values or initial values, or on probabilities for symbols or transmission symbols of the second signal portion 112 determined by the first probability determination 150.

In other words, the probabilities used by the probability determinations 150, 160 for symbols of the respective other signal portion may either be predetermined—for example as initial values—or determined by another device or also determined during the respective other probability determination. In particular, it is also possible to perform the method iteratively so as to improve the probabilities for symbols or transmission symbols of the signal portions alternatingly.

In summary, two series 142, 144 of samples are generated in the receiver 100 in a sample determination, wherein a first sampling in which the first series 142 of samples is obtained is set to sample the first signal portion in an inter-symbol interference-free or low-inter-symbol interference manner, and wherein a second sampling in which the second series 144 of samples is obtained is set to sample the second series 44 of samples with regard to the second signal portion in an inter-symbol interference-free or low-inter-symbol interference manner. Based thereon, probabilities 112 for symbols or transmission symbols of the second signal portion are then determined in the first probability determination 150, taking into account both assumed or predetermined probabilities for transmission symbols of the first signal portion and information on inter-symbol interference between symbols of the second signal portion. For example, based on knowledge of the sampling times of the first sampling and the second sampling, and/or based on knowledge of the time shift between the transmission symbol clock of the first signal portion and the transmission symbol clock of the second signal portion, and also based on, for example, knowledge of the transmission symbol waveforms of the first signal portion and the second signal portion (which are typically known to the receiver 100), it is determined which inter-symbol interference results in particular (different) sequences of transmission symbols of the second signal portion in the first series of samples, and which inter-symbol interference results in particular (different) sequences of transmission symbols of the first signal portion in a sample of the second series 144 of samples. Thus, knowledge of the inter-symbol interference characteristics of the first signal portion and the second signal portion can be exploited in both the first probability determination 150 and the second probability determination 160 to obtain the probabilities 112, 114 for the symbols or transmission symbols of the second signal portion and the first signal portion, respectively, with particularly high reliability. The suitable selection of the sampling times of the first sampling or the second sampling explained above moreover achieves that in the first probability determination 150 taking into account inter-symbol interference between transmission symbols of the first signal portion can be disregarded, and that in the second probability determination 160 taking into account the inter-symbol interference between transmission symbols of the second signal portion can be disregarded. Thus, complexity is kept within a manageable range.

Moreover, it should be noted that the receiver 100 may be supplemented by all the features, functionalities and details that will be described below. The corresponding features, functionalities and details can be included in the receiver 100 both individually and in combination.

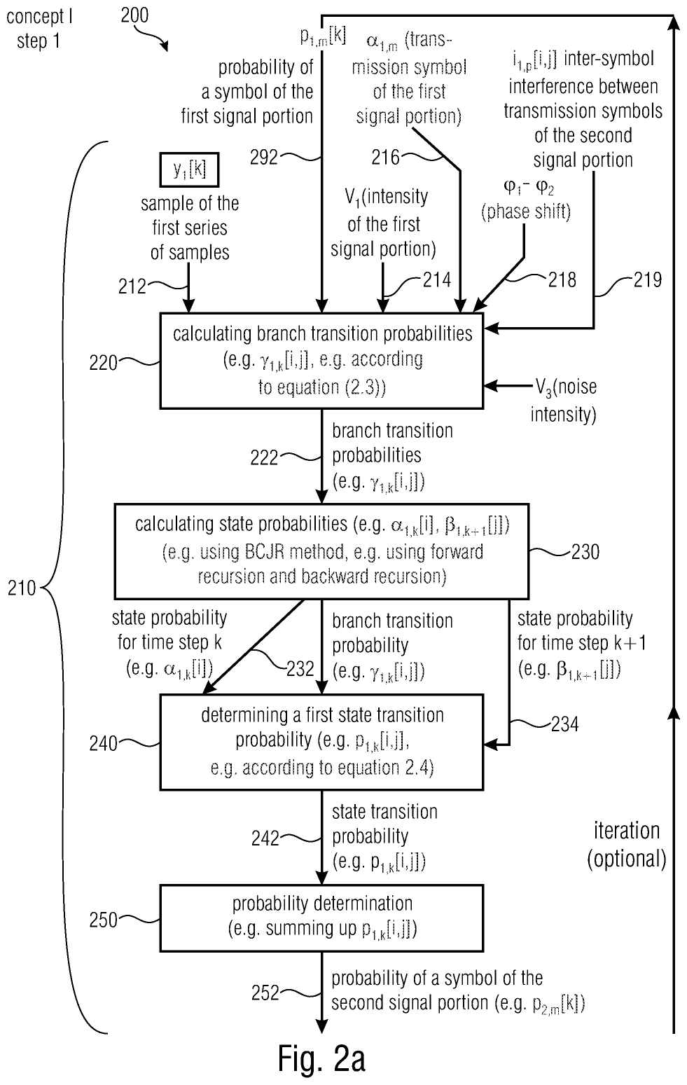

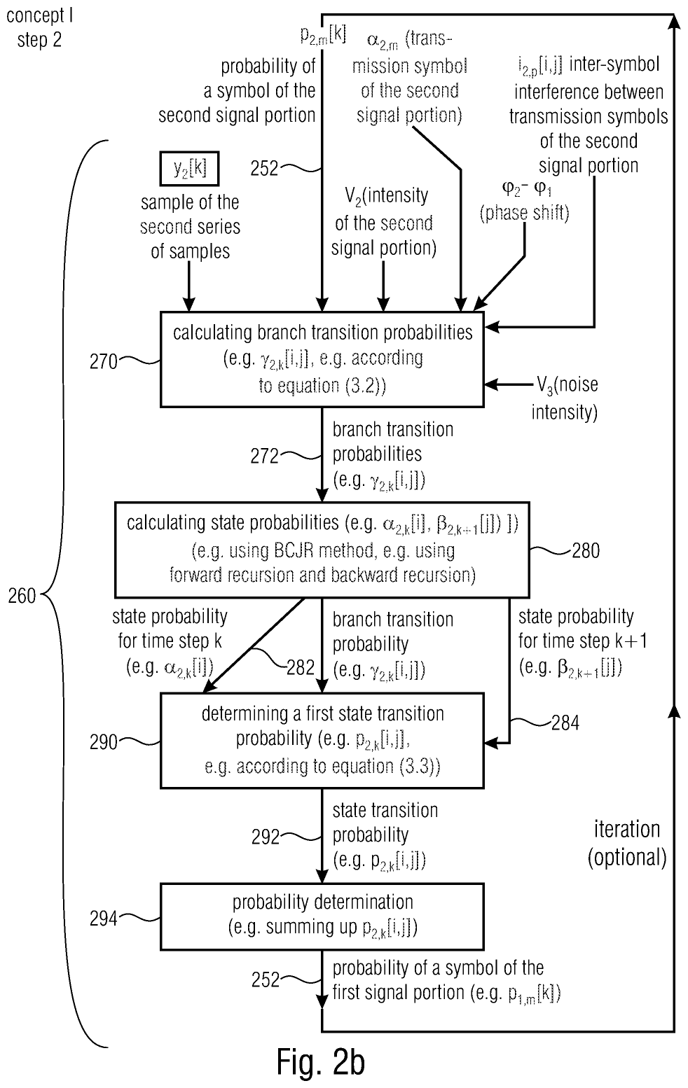

### 2. Concept According to FIGS. 2a and 2b

FIGS. 2a and 2b show a flowchart of a concept for determining probabilities for symbols or transmission symbols of two signal portions. The concept according to FIGS. 2a and 2b in its entirety is denoted by 200.

It should be noted that the concept 200 shown in FIGS. 2a and 2b may be implemented, for example, by the receiver 100. For example, the main processing steps of the concept 200 may be performed by the first probability determination 150 and the second probability determination 160. The samples y₁[k] and y₂[k] used in the processing may be obtained, for example, by the sample determiner 140.

The processing steps are explained in more detail below.

A first processing section 210 includes determining a probability 252 of a symbol of the second signal portion based on a probability 292 of a symbol or transmission symbol of the first signal portion, or based on probabilities of several symbols or transmission symbols of the first signal portion. Of course, probabilities of multiple symbols or transmission symbols of the second signal portion may also be determined in the first processing section 210.

In particular, it should be noted that the first processing section uses, for example, a sample 212 (also denoted by y₁[k]) of the first series 142 of samples. Additionally, the first processing section 210 incorporates assumed or predetermined probabilities of symbols or transmission symbols of the first signal portion (for example at a time with time index k). The probabilities may be assumed to be an initial value, for example, or may be determined in the second processing section 260, for example.

Information 214 on an intensity of the first signal portion (also denoted by v₁) is included into the first processing section 210. Furthermore, information 216 on a transmission symbol of the first signal portion or on a plurality of transmission symbols (for example with index m) of the first signal portion (also denoted by a_{1,m}) is also included into the first processing section 210. In other words, the information 216 on transmission symbols of the first signal portion describes, for example in the form of a complex value, an (expected) contribution of an m-th transmission symbol of the first signal portion to the current sample value y₁[k] of the first series of samples, disregarding transmission symbols of the first signal portion belonging to earlier sampling times or to later sampling times, since a small or negligible inter-symbol interference between transmission symbols of the first signal portion in the first series of samples is assumed. The first processing section 210 further uses information on a phase shift between transmission symbols of the first signal portion and transmission symbols of the second signal portion, denoted, for example, by 218 or φ₁-φ₂. The first processing section 210 further uses information on an inter-symbol interference between transmission symbols of the second signal portion in the samples of the first series 212 of samples (y₁[k]). The information 219 on the inter-symbol interference is also denoted by i_{1,p}[i,j]. For example, the information 219 on inter-symbol interference between transmission symbols of the second signal portion may be calculated for different sequences of transmission symbols of the second signal portion based on the waveform of a transmission symbol typically known to the receiver and based on the phase position of the transmission symbols of the second signal portion with respect to the sampling times of the first sampling. For example, this may take into account all the sequences of transmission symbols of the second signal portion which have an effect on the current sample y₁[k]. Thus, for example, information 219 may be used to describe the contribution to the sample y₁[k] made by different sequences of transmission symbols of the second signal portion due to inter-symbol interference (i.e. superposition of transmission waveforms of transmission symbols of the second signal portion transmitted at different times). For example, the different sequences of transmission symbols of the second signal portion are described by the indices i and j, where i and j can be understood as states in a state machine describing the generation of the sequences of transmission symbols of the second signal portion. In this respect, the transition from a state i to a state j may be understood as a state transition characterizing, for example, a sequence of transmission symbols of the second signal portion.

All in all, it should be noted that the inter-symbol interference values i_{1,p}[i,j] are determinable on the receiver side based on knowledge of the transmission waveform or receive waveform of transmission symbols of the second signal portion and based on knowledge of the sampling times (and, for example, need not be calculated for each iteration step or for the reception of each individual transmission symbol, but rather need only be determined once, as soon as the sampling times are known in more detail, or can even be provided in a predetermined manner in a value table or memory area).

The first method section 210 comprises calculating 220 branch transition probabilities, for example γ_{1,k}[i,j], which may be performed using, for example, equation (2.3). Thus, calculating 220 provides branch transition probabilities, for example γ_{1,k}[i,j]. For example, the branch transition probabilities may be calculated for different combinations of the indices or state indices i and j. For example, a (current) sample y₁[k] of the first series of samples may be included in the calculation 220. Further, calculating 220 may take into account the previously estimated or determined probabilities p_{1,m}[k] of the symbols of the first signal portion (e.g. for the sampling time k). Further, the intensity v₁ of the first signal portion, the (for example, complex-valued) transmission symbols of the first signal portion a_{1,m} typically known to the receiver, the phase shift between the first sampling and the second sampling typically known to the receiver, and the inter-symbol interference between transmission symbols of the second signal portion also determinable by the receiver may be taken into account in the calculation 220. Further, an intensity of a noise or a signal-to-noise ratio determinable by the receiver may also be taken into account by the calculation 220. For details with respect to a possible approach, reference is exemplarily made to the discussion of equation (2.3) below.

The calculation 220 thus obtains branch transition probabilities, e.g. γ_{1,k}[i,j], which may be used in a calculation 230 of state probabilities (e.g., α_{1,k}[i] and β_{1,k+1}[j]). For example, calculating 230 state probabilities may be performed using a forward recursion and a backward recursion method, assuming predetermined or assumed initial and final probabilities. For example, a so-called BCJR method may be used for this purpose, which is familiar to the person skilled in the art. Alternatively, other trellis decoding methods may be used which are also familiar to the person skilled in the art.

Thus, the calculation 230 obtains, for example, state probabilities for time step k, e.g. α_{1,k}[i], and also state probabilities for a time step k+1, e.g. β_{1,k+1}[j], which can be used, for example, together with the branch transition probabilities, e.g. γ_{1,k}[i,j], when determining 240 the first state probabilities, e.g. p_{1,k}[i,j]. This determination of the state transition probabilities p_{1,k}[i,j], which may be done, for example, for different combinations of i and j, or which may even be done, for example, for all meaningful combinations of i and j, may be done, for example, using equation (2.4), which will be discussed further below.

For example, the state transition probabilities p_{1,k}[i,j] may be used in a probability determination 250 to determine probabilities of symbols or transmission symbols of the second signal portion at the time k (e.g. p_{2,m}[k]). This may be done, for example, by suitably summing the values of p_{1,k}[i,j].

In summary, in the first method section 210, probabilities of a symbol of the second signal portion or probabilities of different symbols of the second signal portion or probabilities of all possible symbols of the second signal portion may be determined based on a (current) sample of the first series of samples and also based on assumed or predetermined probabilities of symbols of the first signal portion. Intentional inter-symbol interference between transmission symbols of the second signal portion is exploited in an efficient manner, for example by calculating branch transition probabilities, by deriving state probabilities, and by determining state transition probabilities, wherein a trellis decoding method or BCJR method may be used to take into account inter-symbol interference between transmission symbols of the second signal portion in an efficient manner.

The second method section 260 operates in a similar manner, wherein probabilities of symbols or transmission symbols of the second signal portion are determined based on assumed or predetermined probabilities of symbols or transmission symbols of the first signal portion (e.g. p_{2,m}[k]) and using a sample of the second series of samples (e.g. y₂[k]). As shown in FIG. 2b, the second method section 260 includes calculating 270 branch transition probabilities (e.g. γ_{2,k}[i,j]). For example, calculating 270 branch transition probabilities may be performed according to equation (3.2), which will be described further below. Calculating 270 branch transition probabilities may, for example, take into account a (current) sample y₂[k] of the second series of samples. Further, calculating 270 may take into account probabilities of symbols or transmission symbols of the second signal portion (e.g. p_{2,m}[k]). Further, calculating 270 may take into account an intensity of the second signal portion (v₂) determined by the receiver (which may be absolute or relative, for example defined in relation to an intensity of the first signal portion, or in relation to a noise). Further, calculating 270 branch transition probabilities typically takes into account a receiver-side knowledge of the transmission symbols or the receive symbols (e.g., in the form of a complex-valued representation) (e.g. denoted by a_{2,m}). Further, calculating 270 advantageously takes into account a phase shift between the first sampling and the second sampling. Further, the calculation 270 accounts for information on inter-symbol interference between transmission symbols of the first signal portion in the samples of the second series of samples. Information on the inter-symbol interference (e.g. i_{2,p}[i,j]) may be obtained by the receiver based on, for example, a knowledge of a transmission waveform or receive waveform of the transmission symbols of the first signal portion, and also based on a knowledge of the sampling phase of the second sampling. Thus, it may be determined by the receiver, for example, what contribution different sequences (defined, for example, by i and j) of transmission symbols of the first signal portion provide to the (current) sample y₂[k] of the second series of samples. In particular, the receiver may take into account that several transmission symbols of the first signal portion provide a significant (non-negligible) contribution to the sample value y₂[k], since the second series of samples is not sampled free of inter-symbol interference with respect to the transmission symbols of the first signal portion. On the other hand, when calculating branch transition probabilities, it may in particular be assumed that only a transmission symbol of the second signal portion provides a significant contribution to the current sample y₂[k], whereas, for example, contributions of further transmission symbols (for example, earlier or later transmitted) of the second signal portion to the sample y₂[k] may be neglected by the calculation 270. Accordingly, the calculation 270 may obtain branch transition probabilities (e.g. γ_{2,k}[i,j]) which may be used in calculating 280 state probabilities (e.g. α_{2,k}[i]) and β_{2, k+1}[j]).

The calculation 280 obtains, for example, state probabilities for time step k (e.g. α_{2,k}[i]) and state probabilities for time step k+1 (e.g. β_{2,k+1}[j]). The state probabilities for time step k and the state probabilities for time step k+1 can then be used together with the branch transition probability when determining 290 state transition probabilities (e.g. p_{2,k}[i,j]).

This determination 290 of the first state transition probabilities 292 can be done, for example, using equation (3.3), which will be discussed further below. Thus, the state transition probabilities p_{2,k}[i,j] for different state transitions from state i to state j can be obtained.

The state transition probabilities 291 may then be used in a probability determination 294 to calculate, for example, probabilities of symbols of the first signal portion 292 (e.g. p_{1,m}[k]). Determining the probabilities of the symbols of the first signal portion may be performed, for example, by a suitable summation of state transition probabilities p_{2,k}[i,j]), wherein, for example, the state transition probabilities of those states belonging to a particular transmission symbol (e.g. a_{1,m}) may be summed.

In summary, the calculation 270 substantially corresponds to the calculation 220, the calculation 280 substantially corresponds to the calculation 230, the determination 290 substantially corresponds to the determination 240, and the probability determination 294 substantially corresponds to the probability determination 250, each using quantities adjusted to the appropriate signal portion.

Furthermore, with regard to the concept 200, it should be noted that the concept may, for example, start with the first method section 210 or with the second method section 260, with the respective other method section being carried out subsequently. Incidentally, the process may also be iterative, with the two method sections 210, 260 being carried out, for example, several times in succession and alternatingly. In this way, an iterative improvement of the determination or estimation of the probabilities of the symbols of the two signal portions can be made. Thus, for example, the probability of transmission symbols of the first signal portion determined in the probability determination 294 may be used as input quantity in the calculation 220, and the probabilities of transmission symbols of the second signal portion obtained in the probability determination 250 may be used as input quantities in the calculation 270.

Further details with regard to the concept 200 will be described later. In particular, reference is made to the explanations of the formulae (2.3), (2.4), (3.2) and (3.3) as well as to the other accompanying explanations.

It should further be noted that the concept 200 as shown in FIG. 2 may be supplemented by any of the features, functionalities, and details described herein, either individually or in combination.

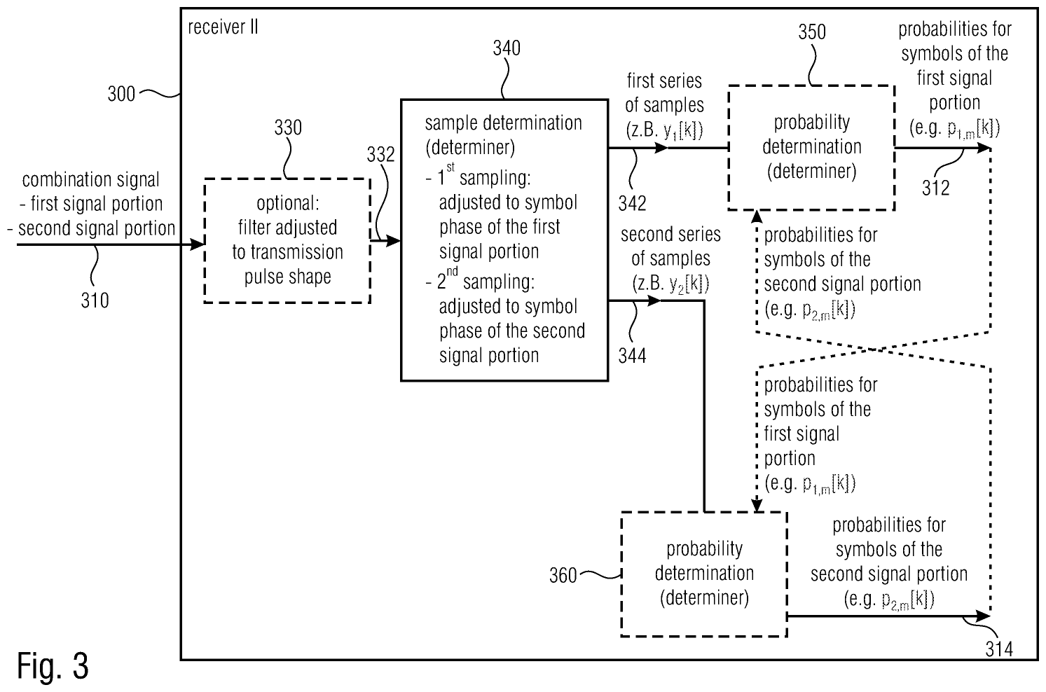

### 3. Receiver According to FIG. 3

FIG. 3 shows a block diagram of a receiver 300 according to an embodiment of the present invention.

The receiver 300 is configured to receive a combination signal 310 having, for example, a first signal portion and a second signal portion. The receiver 300 is further configured to obtain probabilities 312 for symbols of the first signal portion and to obtain probabilities 314 for symbols of the second signal portion. The receiver 300 optionally includes a filter 330 adjusted to a transmission pulse shape, which receives the combination signal 110 and provides a filtered signal 332, for example. The filter 330 may correspond, for example, to the filter 130 of the receiver 100, and the filtered signal 332 may correspond, for example, to the filtered signal 132. The remaining explanations with respect to the possible pre-processing of the combination signal 110, which have been explained with respect to the receiver 100, also apply to the receiver 300.

The receiver 300 further comprises a sample determination 340 which corresponds to, for example, the sample determination 140 of the receiver 100. The sample determination or sample determiner 340 provides, for example, a first series 342 of samples (e.g. y₁[k]) and a second series 344 of samples (y₂[k]). The first series 342 of samples corresponds to, for example, the first series 142 of samples and the second series 344 of samples corresponds to, for example, the second series 144 of samples, so that the above discussions made with respect to the series 142, 144 of samples apply equally.

In summary, the receiver 300 is thus configured to obtain a combination signal 310 comprising two separate signal portions whose pulses are shifted with respect to each other and/or whose carrier waves have a phase difference. The receiver 300 comprises, for example (but not necessarily), a filter adjusted to a transmission pulse shape of the pulses of at least one of the signal portions. The receiver is further configured to obtain, for example, a first series 342 of samples using a first sampling by the sample determination 340, wherein the first sampling is adjusted to a symbol phase of the first signal portion (for example, synchronized to a symbol phase of the first signal portion). The receiver is further configured to obtain, for example, a second series 344 of samples using a second sampling by the sample determination 340, wherein the second sampling is adjusted to a symbol phase of the second signal portion (for example, synchronized to a symbol phase of the second signal portion).

The receiver 300 further comprises a first probability determination 350 configured to determine probabilities for symbols of the first signal portion based on samples of the first sampling (or the first series 342 of samples) and estimated or calculated probabilities for symbols of the second signal portion without taking into account (or while neglecting) inter-symbol interference between transmission symbols of the first signal portion in the samples of the first sampling. The receiver further comprises a second probability determination 360 configured to determine (e.g. updated) probabilities for symbols of the second signal portion based on samples of the second sampling (or second series 344 of samples) and estimated or calculated probabilities for symbols of the first signal portion without taking into account inter-symbol interference between transmission symbols of the second signal portion in the samples of the second sampling. This means that the receiver is configured to obtain probabilities 312 of the transmission symbols of the first signal portion and probabilities 314 of the transmission symbols of the second signal portion for a plurality of sampling times based on the first series 342 of samples and the second series 344 of samples.

With respect to the functionality of the receiver 300, it should be noted that probabilities for symbols or transmission symbols of the second signal portion, which are, for example, based on an assumption or have been determined before, are taken into account when determining the probabilities 312 for symbols of the first signal portion. Thus, for example, the contribution or disturbance contribution of transmission symbols of the second signal portion to a (current) sample (e.g. y₁[k]) of the first series of samples is taken into account (or is taken into account with a certain probability) when determining the probabilities for the symbols or transmission symbols of the first signal portion. This also takes into account the influence of multiple transmission symbols of the second signal portion transmitted in time succession, as these typically all have an influence on a current sample value of the first series of samples. However, since the transmission symbols of the second signal portion are only taken into account as “disturbance” or “disturbance contribution” when determining probabilities for symbols of the first signal portion, and since it is further assumed on the basis of the first sampling that there is no or no significant inter-symbol interference between symbols of the first signal portion in the first series 342 of samples, the probability determination 350 can be performed at comparatively low complexity.

Similarly, when determining probabilities 360, since symbols of the second signal portion are only considered as disturbance or disturbance contribution to the current sample (e.g. y₂[k]) when determining probabilities for symbols of the first signal portion, and since the probability determination 360 further assumes that there is no or no significant inter-symbol interference between transmission symbols of the second signal portion in the second series 344 of samples, the complexity of the probability determination 360 is comparatively low.

Moreover, it should be noted that estimated or previously calculated probabilities for symbols of the second signal portion are included in the probability determination 350, that is when determining probabilities for symbols of the first signal portion. Similarly, estimated or predetermined probabilities for symbols of the first signal portion are included in the probability determination 360, that is when determining probabilities for symbols of the second signal portion. The probability determination 350 and the probability determination 360 may also be performed sequentially or iteratively alternatingly such that the corresponding probabilities for symbols of the two signal portions are each improved. In a first iteration step, for example, assumed probabilities may be used, while in subsequent iteration steps predetermined probabilities may be used.

In summary, the receiver 300 can determine the probabilities for symbols of the two signal portions in a particularly efficient manner. By obtaining two series 342, 344 of samples in the sample determination 340 and by obtaining the probabilities for symbols of the first signal portion based on the first series of samples which are sampled to be adjusted to the symbol phase of the first signal portion, and by obtaining the probabilities for symbols of the second signal portion based on the second series of samples which are sampled to be adjusted to the symbol phase of the second signal portion, the probabilities for the symbols of the two signal portions can be obtained in a very efficient manner. Although inter-symbol interference is advantageously not evaluated step-by-step here, but is only taken into account in summary as a disturbance contribution to the samples, it has been shown that reliable estimates of the probabilities of the symbols of the signal portions can nevertheless be obtained with little effort in many situations.

Further optional details are explained below.

In particular, the receiver 300 may optionally be supplemented by any of the features, functionalities, and details described herein, either individually or in combination.

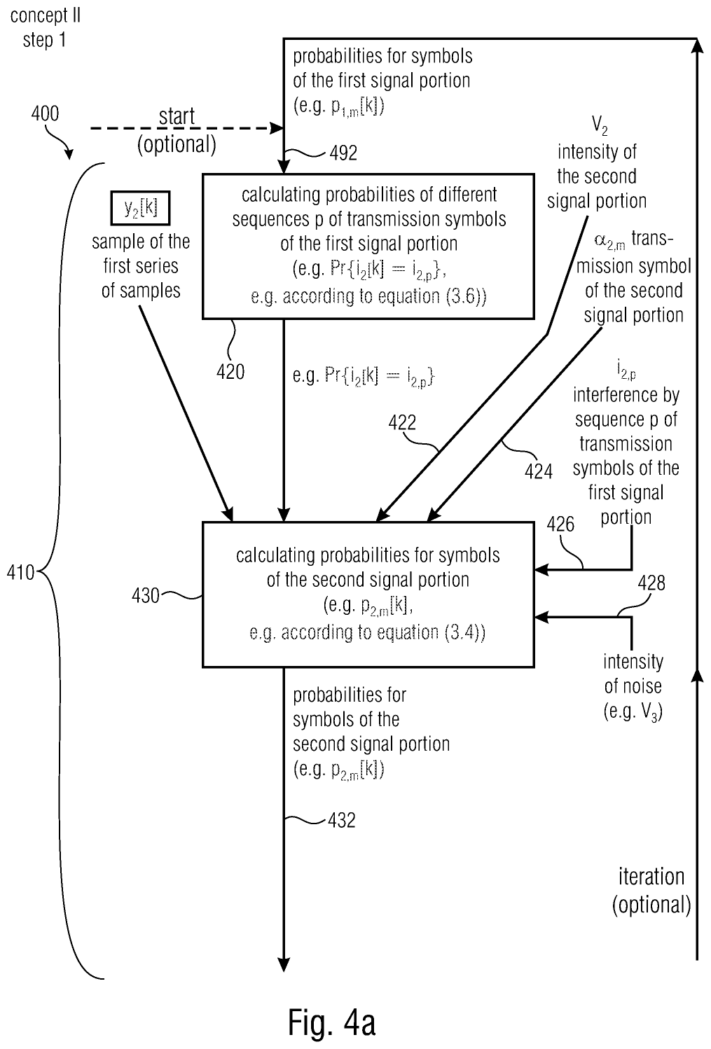

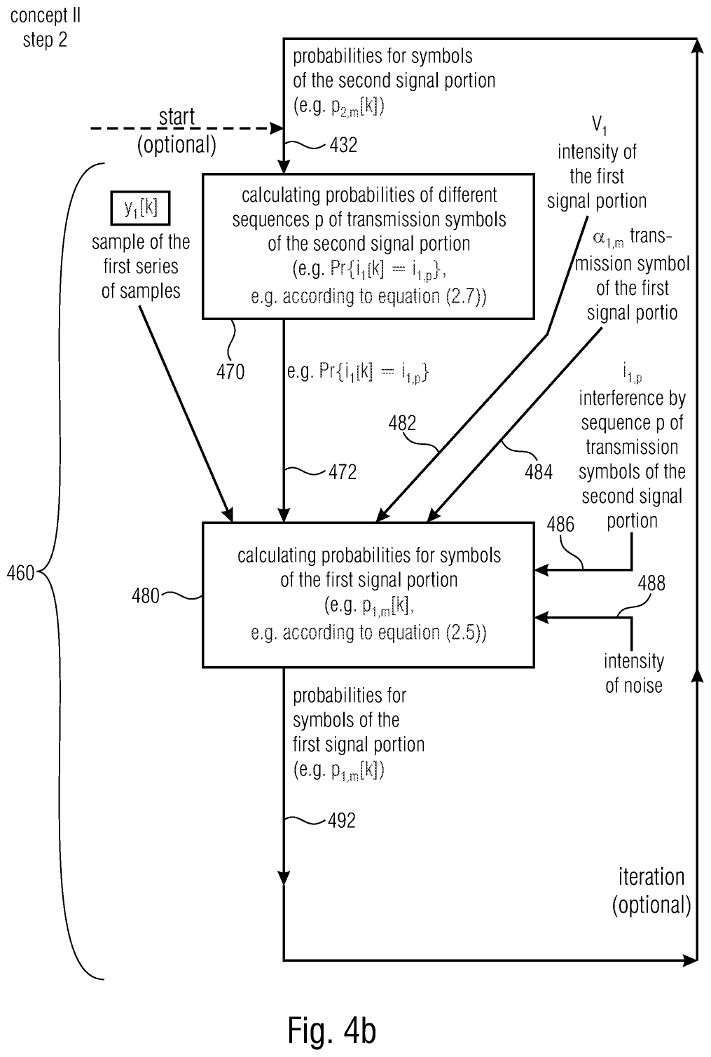

### 4. Concept According to FIGS. 4a and 4b

FIGS. 4a and 4b show a flowchart of a concept for determining probabilities for symbols of a first signal portion and probabilities for symbols of a second signal portion based on samples of a combination signal or a preprocessed combination signal (e.g. filtered to be signal-adjusted. The concept according to FIGS. 4a and 4b in its entirety is denoted by 400.

The concept 400 includes a first method section 410 and a second method section 460.

In the first method section 410, for example, probabilities 432 for symbols of the second signal portion (e.g. p_{2,m}[k]) are determined based on assumed or predetermined probabilities 492 for symbols of a first signal portion (e.g. p_{1,m}[k]) and also based on a (current) sample of the second series of samples (e.g. y₂[k]).

The concept 400 further comprises a second method section 460 in which probabilities 492 for symbols of the first signal portion (e.g. p_{1,m}[k]) are determined based on, for example, (assumed or predetermined) probabilities for symbols of the second signal portion (e.g. p_{2,m}[k]) and also based on a (current) sample of the first series of samples (e.g. y₁[k]).

In this regard, it should be noted that, depending on the circumstances, the first method section 410 may be performed first and then the second method section 460. Alternatively, the second method section 460 may be executed first and then the first method section 410. Further, the first method section 410 and the second method section 460 may be executed alternatingly, for example, in order to iteratively improve the probabilities, associated with a time point (e.g. “k”), for symbols of the first signal portion and the second signal portion. Whether both method sections 410, 460 are run the same number of times or whether one method section is run more frequently than the other, is essentially irrelevant.

In the following, the first method section will be dealt with. However, the corresponding explanations also apply in analogy with regard to the second method section.

For example, the first method section 410 includes determining 420 probabilities of different sequences p (where p is an index of the sequences) of transmission symbols of the first signal portion. For example, the probability Pr{i₂[k]=i_{2,p}} can be determined. For example, the corresponding probability describes the probability of having the sequence p of transmission symbols of the first signal portion, which produces an interference value i_{2,p} in the sample y₂[k] of the second series of samples. For this purpose, for example, on the basis of the knowledge of the transmission waveform or the receive waveform derived by transmission symbols of the first signal portion, it is determined which sequence of transmission symbols of the first signal portion or which sequences of transmission symbols of the first signal portion provide an (disturbance) contribution i_{2,p} to the sample y₂[k]. Then, the probability of the corresponding sequence of transmission symbols of the first signal portion is determined, or, for example, probabilities of several sequences of transmission symbols of the first signal portion, all leading to the (disturbance) contribution i_{2,p} are summed up. For example, if only one sequence (of a plurality of possible sequences or of a total set of possible sequences) of transmission symbols of the first signal portion leads to the (disturbance) contribution i_{2,p}, the probability of this sequence of transmission symbols of the first signal portion can be easily calculated based on the probabilities for transmission symbols of the first signal portion (492), for example according to equation (3.6). In other words, if it is determined by the receiver that a particular sequence of transmission symbols of the first signal portion leads to the (disturbance) contribution i_{2,p} to the sample y₂[k], the probability of this sequence of transmission symbols of the first signal portion can be determined, for example, by multiplying the probabilities of the transmission symbols of the first signal portion belonging to the respective sequence. On the other hand, if several different sequences of transmission symbols of the first signal portion lead to the same or a very similar (disturbance) contribution to the sample y₂[k], the probabilities of these individual sequences can again be obtained by multiplying the probabilities of the transmission symbols belonging to the respective sequences, and the probabilities for the respective sequences can then be added up to obtain an overall probability for the respective (disturbance) contribution i_{2,p}.

It is also possible to determine how many different (disturbance) contributions i_{2,p} there are, which may depend on the signal constellation and also on the length of the inter-symbol interference of the transmission symbols of the first signal portion or the temporal extension of the transmission waveform or the receive waveform belonging to the transmission symbols of the first signal portion. The number of M₁^{L}^{_{dec}}⁺¹ indicated in equation (3.4) should be understood to be an example. It should be noted that different sequences of transmission symbols may lead to the same or a very similar (disturbance) contribution i_{2,p}, so that these sequences can be combined or “clustered”, for example.

In summary, in step 420, for example, the probabilities of different sequences of transmission symbols of the first signal portion may be determined, or alternatively the probabilities of different values of a (disturbance) contribution) i_{2,p}. If a different (disturbance) contribution i_{2,p} is provided for each sequence of transmission symbols, the two calculations are identical. If, on the other hand, identical or almost identical (disturbance) contributions i_{2,p} are obtained by different sequences of transmission symbols of the first signal portion, the number of different (disturbance) contributions i_{2,p} may, for example, be smaller than the number of different sequences of transmission symbols of the first signal portion.

In summary, step 420 may comprise both a determination of probabilities of different sequences p of transmission symbols of the first signal portion and, alternatively, a determination of probabilities of different (disturbance) contributions i_{2,p} (resulting from the different sequences of transmission symbols of the first signal portion). Thus, in step 420, for example, a probability of different sequences p of transmission symbols of the first signal portion or a probability of different (disturbance) contributions i_{2,p} is obtained.

The first method section 410 also includes calculating 430 probabilities for symbols of the second signal portion (e.g. p_{2,m}[k]). The calculation may be performed using, for example, equation (3.4). In this respect, it should be noted that the summation shown in equation (3.4) may, for example, be performed over all different sequences p of transmission symbols of the first signal portion (which contribute to an (disturbance) contribution i_{2,p}≠0) (in which case the probabilities of the different sequences p are advantageously taken into account). The summation may alternatively be performed over all different (disturbance) contributions i_{2,p}, in which case, for example, the probability that a corresponding (disturbance) contribution is i_{2,p} generated by the transmission symbols of the first signal portion may be taken into account.

Further, it should be noted that calculating 430 probabilities for symbols of the second signal portion may take into account a (current) sample (e.g. y₂[k]) of the second series of samples. Furthermore, for example, an intensity 422 (e.g. v₂) of the second signal portion which may be estimated or determined by the receiver may be taken into account. For example, the intensity v₂ of the second signal portion may be determined in absolute terms or may be determined in relative terms (e.g. with respect to the first signal portion or with respect to noise, e.g. in terms of a signal-to-noise ratio). Further, the calculation 430 typically takes into account (e.g. complex-valued) transmission symbols of the second signal portion (e.g. a_{2,m}) known to the receiver. Further, the calculation 430 also takes into account interference from sequences p of transmission symbols of the first signal portion (e.g. i_{2,p}; also referred to as “(disturbance) contribution of transmission symbols of the first signal portion to the sample y₂[k]”).

As mentioned, the calculation 430 of probabilities for symbols of the second signal portion may be performed using, for example, equation (3.4). This may also take into account an intensity of the noise (e.g. v₃) or a signal-to-noise ratio.

The calculation thus determines, for example, the probability of the various symbols of the second signal portion, wherein, for example, partial probabilities are summed up under the assumption of various (disturbance) contributions i_{2,p}. For example, it is checked how probable a transmission symbol a_{2,m} is, given the sample y₂[k], the interference i_{2,p}, the intensity of the second signal portion (e.g. v₂) and the intensity of the noise (e.g. v₃), assuming a Gaussian distribution of the noise, for example.

The probabilities 232 for symbols of the second signal portion (e.g. p_{2,m}[k]) determined in step 430 may then be output, for example, or may also be used in the second method section 460.

The second method section 460 runs essentially parallel to the first method section 410, so that the above explanations—adapted correspondingly—also apply.

In the second method section 460, probabilities 492 for symbols of the first signal portion (e.g. p_{1,m}[k]) are determined based on probabilities 432 for symbols of the second signal portion (e.g. p_{2,m}[k]) and also based on a (current) sample (e.g. y₁[k]) of the first series of samples.

The second method section 460 includes determining 470 probabilities of different sequences of transmission symbols of the second signal portion (e.g. Pr{i₁[k]=i_{1,p}}), which may be performed based on, for example, the information 432 on probabilities for symbols of the second signal portion. Equivalently to determining probabilities of different sequences of transmission symbols of the second signal portion, a determination of probabilities of different (disturbance) contributions of the second signal portion (e.g. i_{1,p}) to the current sample y₁[k] may also be determined. In this regard, the above discussion made regarding the determination 420 applies here correspondingly. For example, the determination 470 may be made using equation (2.7), or using an equation corresponding to equation (2.7) and adjusted to the particular symbol sequence. In other words, probabilities of transmission symbols of the second signal portion belonging to a sequence of transmission symbols of the second signal portion currently under consideration may be multiplied. Optionally, probabilities of different sequences of transmission symbols of the second signal portion leading to the same (disturbance) contribution i_{1,p} may be summed up, for example if the probabilities of different (disturbance) contributions are to be determined.

Probabilities 472 of different sequences of transmission symbols of the second signal portion or probabilities of different (disturbance) contributions i_{1,p} are determined by the determination 470, for example.

The second method section 460 further comprises calculating 480 probabilities for symbols of the first signal portion (e.g. p_{1,m}[k]). This calculation 480 may be performed using, for example, equation (2.5). The calculation of probabilities for symbols of the first signal portion may include, for example, a current sample y₁[k] of the first series of samples. Furthermore, the probabilities of different sequences of transmission symbols of the second signal portion determined in step 470 or the probabilities of different (disturbance) contributions i_{1,p} determined in step 470, may be taken into account when calculating 480 probabilities for symbols of the first signal portion. Furthermore, information 482 on an intensity of the first signal portion (e.g. v₁) may be included in the calculation 480, wherein the information 482 on the intensity of the first signal portion may be determined, for example, in an absolute or relative manner (e.g. with respect to the second signal portion or with respect to a noise) by the receiver. Further, the calculation 480 typically comprises information, known to the receiver, on the transmission symbols of the first signal portion (a_{1,m}), also denoted by 484. For example, the information 484 may describe what (for example, complex) sample the various transmission symbols of the first signal portion (with index m) would result in in the absence of inter-symbol interference between transmission symbols of the first signal portion, in the absence of (disturbance) contribution i_{1,p} and in the absence of noise (as well as in the absence of other disturbance). In other words, the information 484 describe the ideal transmission symbols or the receive symbols caused by the different transmission symbols in the ideal case. Furthermore, the calculation 480 takes into account the interference (or the (disturbance) contribution) i_{1,p}, which results from the different sequences p of transmission symbols of the second signal portion. The corresponding contribution is also denoted by 486. Furthermore, an intensity 488 of the noise, which may, for example, be determined by the receiver, is also taken into account in the calculation 480.

Thus, the calculation 480 obtains total probabilities for transmission symbols of the first signal portion (e.g. p_{1,m}[k]), also denoted by 492. The probabilities 492 may be output, for example, or may be used or reused in the first method section 410 for the determination 420.

For example, as mentioned with respect to the calculation 420, the calculation 480 may determine how likely it is, given the current sample y₁[k] of the first series of samples, that a particular transmission symbol (with index m) was transmitted at a time step k, when the interference i_{1,p} by various possible sequences p of transmission symbols of the second signal portion, as well as an intensity of noise and also an estimated intensity of the first signal portion are taken into account, while disregarding inter-symbol interference between transmission symbols of the first signal portion.

In summary, in the concept 400, both probabilities for transmission symbols of the first signal portion and probabilities for transmission symbols of the second signal portion can be determined in a very efficient manner. An efficient determination is realized by obtaining two series of samples and by refraining from taking into account details of inter-symbol interference.

Further explanations can be found below.

The concept 400 as shown in FIG. 4 may optionally be supplemented by any of the features, functionalities, and details described herein. In particular, the formulae described below may be used to perform the various method steps. Alternatively, however, modified formulae may be used to achieve the corresponding functionality. Moreover, it should be noted that the concept 400 may be supplemented by the features, functionalities and details described herein, both individually and in combination.

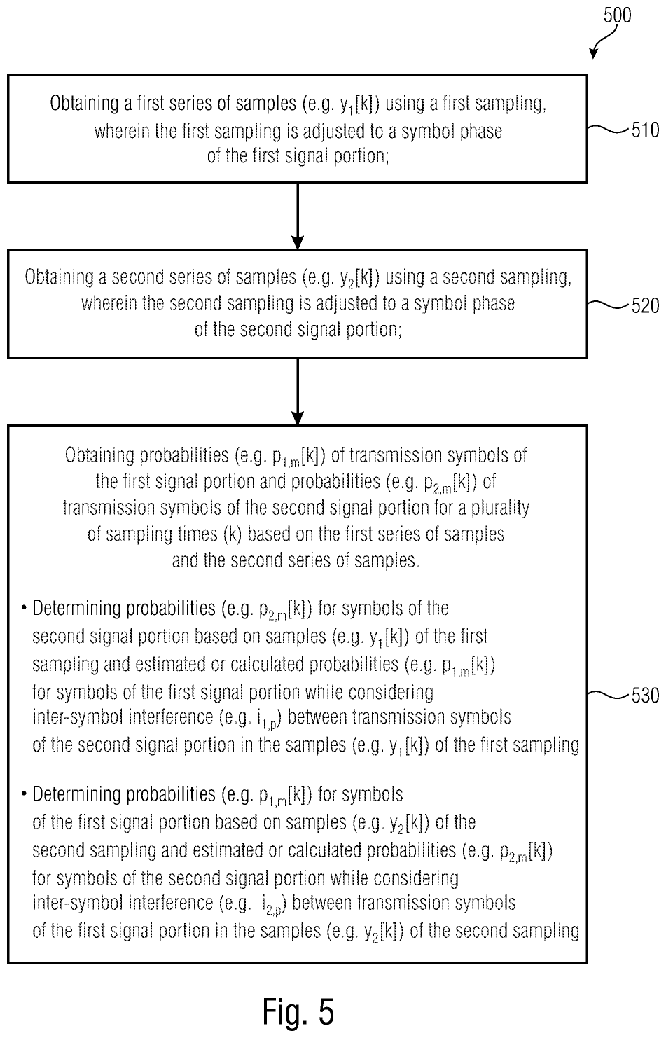

### 5. Method According to FIG. 5

FIG. 5 shows a flowchart of a method 500 for receiving a combination signal having two separate signal portions whose pulses are shifted with respect to each other and/or whose carrier waves have a phase difference.

The method comprises obtaining 510 a first series of samples using a first sampling, wherein the first sampling is adjusted to a symbol phase of the first signal portion.

The method further comprises obtaining 520 a second series of samples using a second sampling, wherein the second sampling is adjusted to a symbol phase of the second signal portion. For example, the sampling may be performed in parallel or sequentially. Obtaining 510 the first series of samples and obtaining 520 the second series of samples may be performed, for example, in parallel or sequentially.

The method 500 further comprises obtaining 530 probabilities of transmission symbols of the first signal portion and probabilities of transmission symbols of the second signal portion for a plurality of sampling times based on the first series of samples and the second series of samples. Obtaining 530 probabilities may include, for example, determining probabilities of symbols of the second signal portion based on samples of the first sampling and estimated or calculated probabilities of symbols of the first signal portion while taking into account inter-symbol interference between transmission symbols of the second signal portion in the samples of the first sampling. Obtaining 530 probabilities may further comprise determining probabilities of symbols of the first signal portion based on samples of the second sampling and estimated or calculated probabilities for symbols of the second signal portion while taking into account inter-symbol interference between transmission symbols of the first signal portion in the samples of the second sampling.

The method 500 may optionally be supplemented by any of the features, functionalities, and details described herein, either individually or in combination. In particular, the method 500 may also be supplemented by any features, functionalities and details described herein with respect to the inventive devices.

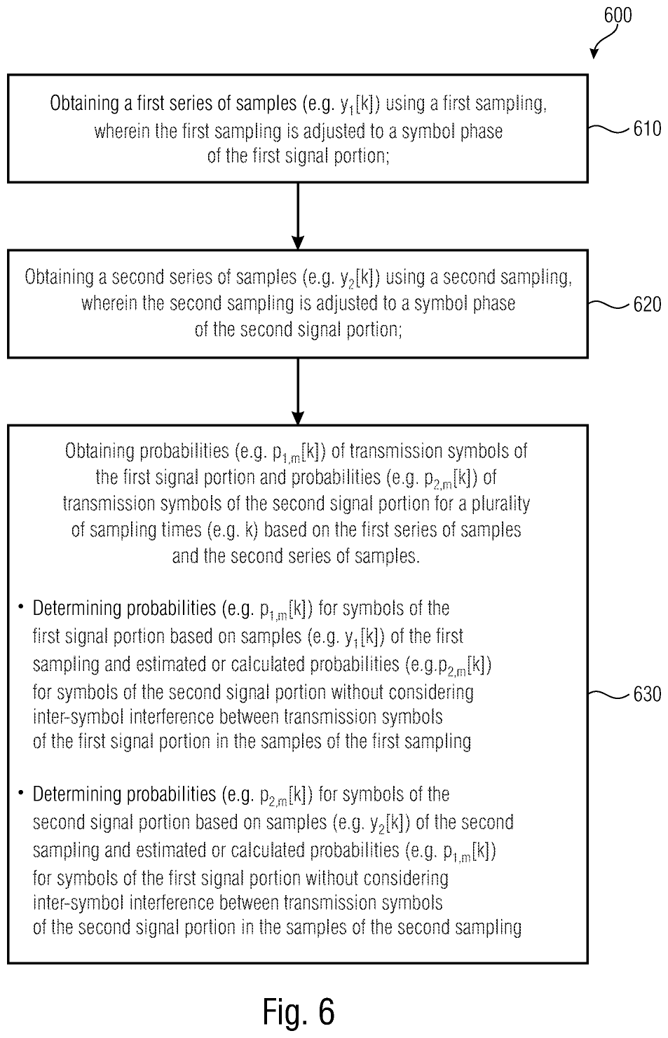

### 6. Method According to FIG. 6

FIG. 6 illustrates a flowchart of a method 600 for receiving a combination signal having two separate signal portions whose pulses are shifted relative to each other and/or whose carrier waves have a phase difference. The method comprises obtaining 610 a first series of samples using a first sampling, the first sampling being adjusted to a symbol phase of the first signal portion. The method 600 further comprises obtaining 620 a second series of samples using a second sampling, wherein the second sample is adjusted to a symbol phase of the second signal portion. Obtaining 610 the first series of samples and obtaining 620 the second series of samples may be performed, for example, in parallel or sequentially.

The method 600 further comprises obtaining 630 probabilities of transmission symbols of the first signal portion and probabilities of transmission symbols of the second signal portion for a plurality of sampling times based on the first series of samples and the second series of samples. For example, obtaining 630 probabilities includes determining probabilities for symbols of the first signal portion based on samples of the first sampling and estimated or calculated probabilities for symbols of the second signal portion without taking into account inter-symbol interference between transmission symbols of the first signal portion in the samples of the first sampling. Obtaining 630 probabilities further comprises determining probabilities for symbols of the second signal portion based on samples of the second sample and estimated or calculated probabilities for symbols of the first signal portion without taking into account inter-symbol interference between transmission symbols of the second signal portion in the samples of the second sampling.

The method 600 may be supplemented by any of the features, functionalities and details described herein, either individually or in combination. In particular, the method 600 may also be supplemented by any features, functionalities and details described herein with respect to the inventive devices.

### 7. Further Embodiments

Further embodiments are described below. In particular, a technical environment and background will be explained. Furthermore, an iterative separation according to the non-prepublished German patent applications 10 2018 202 648 and 10 2018 202 649 (references [1] and [2]) will be described. Receiver concepts for an optimized 2-user receiver are described. An initial situation and preprocessing will be discussed. Furthermore, iterative separation using a modified BCJR algorithm is described. In this respect, for example, a first step (step 1) and a second step (step 2) are described.

Furthermore, suggestions for extensions or modifications according to aspects of the invention are explained. Thus, an extension or modification to a dual inter-symbol interference (ISI) exploitation is described. Furthermore, an extension or modification to a dual complexity reduced processing without BCJR is described. Furthermore, an extension or modification to mutually different carrier frequencies is described.

Furthermore, some embodiments are discussed.

7.1 Technical Environment and Background

With regard to the technical environment, reference is made, for example, to the non-prepublished German patent applications 10 2018 202 647, 10 2018 202 648 and 10 2018 202 649.

7.2. Iterative Separation According to the Non-Prepublished German Patent Applications 10 2018 202 648 and 10 2018 202 649 (References [1] and [2]).

7.2.1 Receiver Concepts for an Optimized Two-User Receiver

Receiver concepts for an optimized two-user receiver which can be used in embodiments according to the present invention, for example in modified form, are described below.

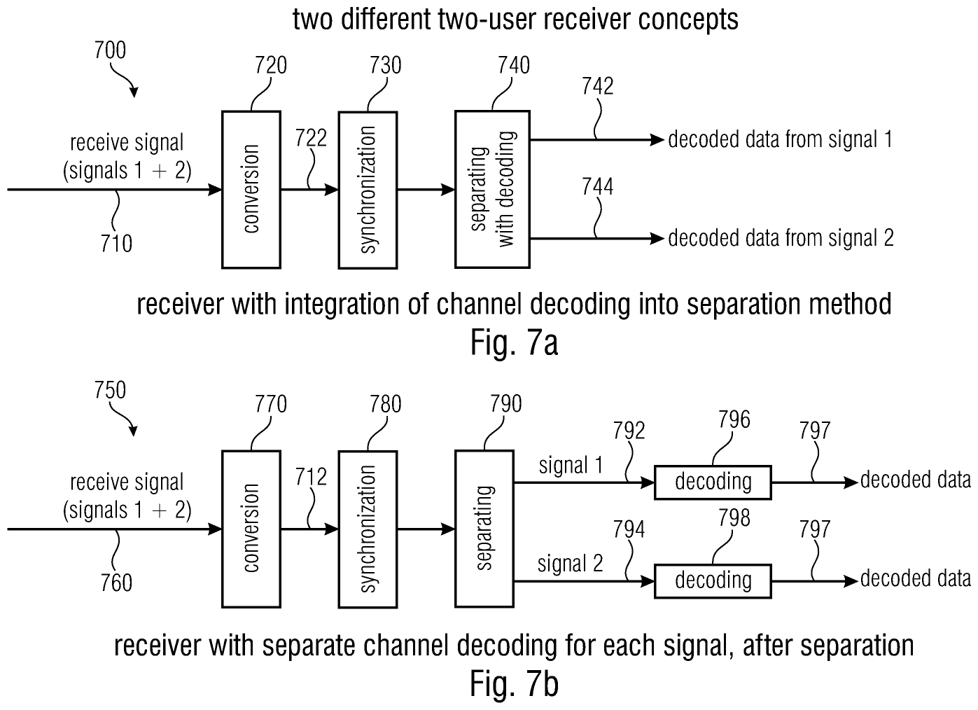

FIG. 7a shows a schematic diagram of a receiver with integration of channel decoding into the separation process. The receiver according to FIG. 7a in its entirety is designated by 700. The receiver 700 receives a receive signal 710 comprising, for example, a first signal (signal 1) and a second signal (signal 2) or a first signal portion and a second signal portion.

The receiver 700 includes receive signal conversion 720 configured, for example, to convert the receive signal 710 to a frequency, such as an intermediate frequency range or a baseband. The conversion 720 may, for example, generate a complex-valued output signal having an in-phase component and a quadrature component. An output signal of the conversion 720 is designated by 722.

The receiver 700 further comprises a synchronization 730 which may, for example, analyze the receive signal 710 or the converted receive signal 722 and may, for example, determine one or more parameters of the receive signal or the converted signal 722. For example, the synchronization 730 may determine a carrier frequency, carrier phase, symbol duration, or symbol phase, and may, for example, control a sample or multiple samples accordingly or synchronize the same to the receive signal 710 or the converted receive signal 722.

The receiver 700 further comprises separation with decoding 740. For example, the separation and decoding may determine decoded data 742 of the first signal (e.g. signal 1) or first signal portion and decoded data 744 of the second signal (e.g. signal 2) or second signal portion based on the receive signal or converted receive signal 722 or based on samples based on the receive signal 710 or converted receive signal 722.

Further details will be provided below.

FIG. 7b shows a schematic diagram of a receiver with separate channel decoding for each signal after separation. The receiver according to FIG. 7b in its entirety is designated by 750. The receiver 750 is configured to receive a receive signal 760 corresponding, for example, to the receive signal 710. The receiver 750 further comprises conversion 770 corresponding, for example, to the conversion 720 of the receiver 700. The receiver 750 further comprises synchronization 780 corresponding, for example, to the synchronization 730 of the receiver 700. The receiver 750 further comprises separation 790 configured to obtain, for example, a first signal (for example, signal 1) or a first signal portion 792 and a second signal (for example, signal 2) or a second signal portion 794. For example, the separation 790 may obtain the first signal 792 and the second signal 794 based on the receive signal or the converted receive signal 772 or based on samples which are based on the receive signal 760 or on the converted receive signal 772.

The receiver 750 further comprises first decoding 796 configured, for example, to obtain first decoded data 794 based on the first signal 792. The receiver 750 further comprises second decoding 798 configured to obtain second decoded data 797 based on the second signal or signal portion 794.

Further details will be provided below.

In summary, FIGS. 7a and 7b describe two receiver concepts for a two-user receiver. In both receiver concepts, a multi-carrier signal (e.g. the receive signal 710 and 760) is converted to the equivalent complex baseband after reception (block conversion 720, 770 in FIGS. 7a and 7b) and the parameters or modulation parameters (e.g. carrier frequency and/or carrier phase and/or symbol duration and/or symbol phase and/or modulation method and/or signal power) are estimated (e.g. in block “synchronization” 730, 780). However, the concepts differ from each other in the processing thereafter.

In the first concept according to FIG. 7a, channel decoding is performed in the separation process (for example, in the block “separation with decoding” 740 in FIG. 7a). At the output, the decoded data 742, 744 of both signals or signal portions are present to be separated from each other.

In the second concept according to FIG. 7b, channel coding is not utilized for the separation procedure, so that after separation (block “separation” 790), the decoded data are calculated from the reliability information of the channel bits (for example, of the first signal 792 and the second signal 794) by means of channel decoding (e.g. by first decoding 796 and second decoding 798). Here, the channel coding method used at the transmitter should (or in some cases must) be known.

An iterative procedure is proposed as the separation method, which is described in the following sections.

In summary, the functionalities or functional blocks as shown in FIGS. 7a and 7b may be included, for example, in the receivers 100 and 300 according to FIGS. 1 and 3, individually or in combination. For example, the conversion 720, 770 may be used as part of pre-processing in the receivers 100, 300. Similarly, the synchronization 730, 780 may be employed in the receivers 100, 300, and may, for example, drive the sample determinations 140, 340 suitably or synchronize to a transmission symbol clock or to a transmission symbol phase. Further, the probability determinations 150, 160 may correspond to the separation 790 (or separation 740). Alternatively, for example, the probability determinations 350, 360 may correspond to the separation 790 (or separation 740).

It should be noted, moreover, that the concepts described herein for determining probabilities of transmission symbols of two signal portions may be used, for example, in the context of separation 740 and/or in the context of separation 790.

For example, the concept 200 according to FIG. 2 may be used in the context of the separation 740 and in the context of the separation 790. Alternatively, the concept 400 according to FIG. 4 may be used in the context of separation 740 or in the context of separation 790.

In other words, the receiver concepts described with reference to FIGS. 7a and 7b may optionally be supplemented by any of the features, functionalities and details described herein, either individually or in combination. In particular, the concepts described below can also be used to determine probabilities of transmission symbols or for signal separation in the receivers 700, 750.

7.2.2 Initial Situation

In the following, some conditions are described which should be fulfilled in embodiments of the invention.

The following conditions are assumed:
Two signals are received which overlap in the frequency range and are transmitted continuously in the observed time frame. These signals or signal portions are included, for example, in the combination signal 110 or the combination signal 310 or the receive signal 710 or the receive signal 760.
Both signals (or signal portions) use digital pulse amplitude modulation (PAM), which includes amplitude-shift keying (ASK), phase-shift keying (PSK), and quadrature amplitude modulation (QAM), as well as all mixed forms and differential precoding.
For pulse shaping, square-root Nyquist pulses, such as root-raised cosine (RRC) pulses, are used on the transmitter side, as is generally the case.
The symbol rates and carrier frequencies of both signals (or signal portions) are approximately identical.

It should now be noted that the above conditions do not necessarily have to be met. Rather, in some cases, one or more or all of the above conditions may be deviated from.

7.2.3 Preprocessing

In the following, a possible pre-processing is described which may be used, for example, in starting examples according to the present invention. For example, the receive signal is first converted to the equivalent complex baseband. This may be done, for example, as part of preprocessing in receivers 100 or 300, or as part of conversion 720 or conversion 770. For example, the signal is shifted to the baseband at the estimated carrier frequency.

After estimating the symbol rate, the signal passes through, for example, a signal-adjusted filter or “matched filter” (i.e. matching the transmit filter for maximum noise limitation) and is sampled at the symbol rate. Filtering may be done, for example, by the transmission pulse shape-adjusted filter 130 or the transmission pulse shape-adjusted filter 330, and the sampling may be done, for example, by the sample estimator 140 or the sample estimator 340. The symbol rate estimation may be performed by, for example, the synchronization 730 or the synchronization 780, and the filtering and sampling may be performed in, for example, the separation 740 or the separation 790.

The symbol phase is selected such that one signal, hereinafter referred to as signal 1 (or first signal, or first signal portion), is sampled at the optimal times, i.e. is inter-symbol interference (ISI)-free. In this case, signal 2 (or second signal, or second signal portion) is usually not sampled for the correct timing, resulting in inter-symbol interference (ISI). Also, the signal is synchronized to the estimated carrier phase of signal 2, for example. The following discrete-time signal y₁[k], for example, is now present at the output of the synchronization at time step k:

y₁[k]=α₁[k]v₁e^{j(φ}^{₁}^{-φ}^{₂}⁾Σ_{k′=-∞}^{∞α}₂[k′]v₂g₀((k−k′)T+(T₁−T₂))+v₃n₁[k], (2.1)

with the following quantities:

a₁[k]∈{α_{1,0}, α_{1,1}, . . . , α_{1,M}_{₁₋₁}} and α₂ [k] ∈{α_{2,0}, α_{2,1}, . . . , α_{2,M}_{₂₋₁}}: data-carrying symbols, wherein M₁ and M₂ represent the number of constellation points of signals 1 and 2.

v₁, v₂, v₃: gain factors of signal 1, 2 and of the additive white Gaussian noise

g₀(t): total pulse shape from transmission and receive filter, as well as transmission channel carrier phases of signals 1 and 2

φ₁, φ₂: symbol phases, i.e. time shift to the optimal sampling times of signal 1 and 2

n₁[k] additive, white, Gaussian noise with variance 1

For example, index 1 represents the first processing part, whereas the second processing part is only introduced in the extension in section 7.3.1.

7.2.4 Iterative Separation Using a Modified BCJR Algorithm

The two symbol sequences α₁[k] and α₂ [k] can be detected, for example, with the help of a Viterbi algorithm. The number of states is, for example M₂^{L}^{_{dec}}⁻¹, wherein L_{dec} represents the number of ISI taps taken into account. Between the states, there are M₁·M₂ transitions, which is why the complexity increases sharply in higher-level modulation schemes. The number of states increases when a common trellis decoding scheme is used when convolutional codes are used as the channel code to increase power efficiency.

In order to reduce the enormous effort due to the high number of states, an iterative method can be used, for example, in which the two symbol sequences are detected separately from each other in each iteration step and the respective other signal is included in the detection as disturbance. For this purpose, for example, the a-posteriori probabilities for the symbols α₁[k] and α₂ [k] are calculated iteratively, wherein in the first step, for example, all probabilities are assumed to be identical. Here, a modified BCJR algorithm is applied in each iteration, which is described in Section 7.2.4.1, wherein BCJR stands for Bahl, Cocke, Jelinek, and Raviv and is an algorithm for trellis decoding. Before doing so, a few definitions are introduced. The approximated ISI value, present at time step k, i₂[k] of signal 2 which acts as interference on signal 1, for example, is described by

$${i}_{1} [ k ] = {\sum }_{{k}^{′} = k - {L}_{dec} \text{/} 2}^{k + {L}_{dec} {\text{/}}^{2}} {a}_{2} [ {k}^{′} ] {v}_{2} {g}_{0} ( ( k - {k}^{′} ) T + ( {T}_{1} - {T}_{2} ) ) . \qquad ( 2.2 )$$

Note: The index 1 at i₁[k] refers to the processing path 1 in y₁[k]. For example, there are M₂^{L}^{_{dec}}⁺¹ possible values for i₁[k]. After the synchronization parameters are available, these hypothetical values can be calculated and are given the designation i_{1,p} with index p∈{0, 1, . . . , M₂^{L}^{_{dec}}⁺¹−1}.

The a-posteriori probability that α₁[k]=α_{1,m} was sent is denoted by p_{1,m}[k] and equivalently the a-posteriori probability that α₂[k]=α_{2,m}, was sent by p_{2,m}[k],

The BJCR algorithm works block by block, i.e. a certain number of symbols are first collected as a block before the a-posteriori probabilities of the transmission symbols on this block are estimated iteratively. Since, in time step k in (2.2), L_{dec}/2 symbols are needed both before and after k, the block size is extended by L_{dec}/2 but the added symbols themselves are not estimated again. Equally probable values are assumed as the a posteriori probabilities of the symbols which have not yet been estimated. Once the estimation of the symbols of a block is finished, the temporally successive block is processed, wherein the blocks overlap in time, so that the successive block, for its first symbols (at least L_{dec}/2 already has estimated values for their a-posteriori probabilities.

In other words, knowing the symbol phases T₁ and T₂ as well as the overall pulse shaping g₀(T) as well as the constellation points associated with different data-carrying symbols, the receiver can determine the values i₁ [k] and i_{1,p} for different possible sequences of data symbols and transmission symbols of the second signal portion. The symbol phases T₁ and T₂ may be determined, for example, by an analysis of the receive signals of the synchronization by the receiver. The total pulse g₀(t) may equally be known to the receiver 750, since the receiver typically knows the predetermined transmission and receive filters and can make an estimate of the channel characteristics. Thus, it becomes readily possible to determine i_{1,p} or i_{2,p}, for example. Other approaches to determining i_{1,p} are, of course, also possible.

7.2.4.1 Step 1

In step 1, an estimation of the a-posteriori probabilities for signal 2 from the a-posteriori probabilities of signal 1 is performed using the modified BCJR algorithm. When traversing the trellis, the BCJR first generates non-normalized branch transition probabilities γ_{1,k}[i,j] in the k-th time step from state i to state j using

$${γ}_{1 , k} [ i , j ] = {\sum }_{m = 0}^{{M}_{1} - 1} {p}_{1 , m} [ k ] {e}^{- \frac{{\vert {y}_{1} [ k ] - ( {v}_{1} {α}_{1 , m} {e}^{j ( {φ}_{1} - {φ}_{2 )}} + {i}_{1 , p} ) \vert}^{2}}{{v}_{3}^{2}}} \qquad ( 2.3 )$$

wherein i_{1,ρ} corresponds to the ISI value associated with the branch i→j. Note: The index 1 at γ_{1,k} [i,j] refers to the processing path 1 in γ₁ [k].

Then, the calculated values γ_{1,k}[i,j] for all k, i, j are used to perform forward and backward recursion. In the forward recursion, the probability α_{1,k}[i] for a state i at the k-th time step is calculated by including the state probabilities up to the time step k−1. In the backward recursion, the probability β_{1,k} [i] for a state i at the k-th time step is calculated by including the probabilities of the subsequent states up to time step k.

A estimation of the state transition probability p_{1,k}[i,j] can then be done by

p_{1,k}(i,j)=c_{trans,k}α_{1,k}[i]γ_{1,k}[i,j]γ_{1,k+1}[j], (2.4)

wherein ctrans,ₖ is to be selected such that the sum of the probabilities at each time step equals 1.

The a-posteriori probabilities p_{2,m}[k] can now be determined by summing up the state transition probabilities p_{1,k}[i,j] which belong to the respective symbol α_{2,m}.

7.2.4.2 Step 2

In step 2, an estimation of the a-posteriori probabilities for signal 1 from the a-posteriori probabilities of signal 2 is performed by adding the individual probabilities of all possible ISI points.

The a-posteriori probabilities p_{1,m} [k] for signal 1 are determined as follows:

$${p}_{1 , m} [ k ] = {c}_{1 , sbs} {\sum }_{p = 0}^{{M}_{2}^{{L}_{dec} - 1}} Pr \{ {i}_{1} [ k ] = {i}_{1 , p} \} {e}^{- \frac{{\vert {y}_{1} [ k ] - ( {v}_{1} {α}_{1 , m} + {i}_{1 , p} ) \vert}^{2}}{{v}_{3}^{2}}} \qquad ( 2.5 )$$

wherein the a-priori probabilities Pr{i₁[k]=i_{1,p}} are calculated from the product of the L_{dec}+1 a-posteriori probabilities p_{2,m}[k] which belong to i_{1,p}. For example, if the interference value p=0 belongs to the symbol sequence

{α₂[k−L_{dec}/2]=α_{1,0};α₂[k−L_{dec}/2+1]=α_{2,0}; . . . α₂[k+L_{dec}/2]=α_{2,0}}, (2.6)

then the value for Pr{i₁[k]=i_{1,0}} is calculated by

Pr{i₁[k]=i_{1,0}}=p_{2,0}[k−L_{dec}/2]·p_{2,0}[k−L_{dec}/2+1] . . . p_{2,0}[k+L_{dec}/2]. (2.7)

Furthermore, c_{1,sbs} is selected in such a way that the sum of all a-posteriori probabilities p_{1,m}[k] equals 1.

7.3. Proposals for Extensions

In the following, extensions or variations of the concept described in section 7.2 according to embodiments of the present invention are described. The concepts described herein may be used in embodiments according to the present invention, also in connection with the concepts described in section 7.2.

In particular, embodiments according to the invention may be obtained by modifying the arrangements described in section 7.2 based on the concepts according to sections 7.3.1 and/or 7.3.2 and/or 7.3.3.

7.3.1 Extension to Dual ISI Utilization

An idea according to one aspect of the present invention is to extend the BCJR method (e.g. according to section 7.2.4) to include additional pre-processing, thereby allowing detection of the ISI portion using BCJR to be applied twice so that the ISI memory of both signals can be exploited.

For this purpose, the following signal is calculated (or assumed or obtained by sampling), in addition to y₁[k]:

y₂[k]=α₂[k]v₂e^{j(φ}^{₂}^{-φ}^{₁}⁾+Σ_{k′=-∞}^{∞α}₁[k′]v₁g₀((k−k′)T+(T₂−T₁))+v₃n₂[k]. (3.1)

Thus, a second processing is added, now synchronizing to the symbol phase of signal 2 and, for example, to the carrier phase of signal 1. The noise portion n₂ [k] is strongly correlated with n₁ [k]. This is not exploited in further processing, but can optionally be done for further improvement in power efficiency.

The separation is done in the same way as described in section 7.2.4, but in step 2, instead of applying equation (2.5), a second instance of the BCJR algorithm is now applied to the detection of the ISI states of signal 1, swapping the two indices representing the signals. Equations (2.3) and (2.4) thus become

$$\begin{matrix}{γ}_{2 , k} [ i , j ] = {\sum }_{m = 0}^{{M}_{2} - 1} {p}_{2 , m} [ k ] {e}^{- \frac{{\vert {y}_{2} [ k ] - ( {v}_{2} {α}_{2 , m} {e}^{j ( {φ}_{2} - {φ}_{1 )}} + {i}_{2 , p} ) \vert}^{2}}{{v}_{3}^{2}}} \\ and & ( 3.2 ) \\ {p}_{2 , k} ( i , j ) = {c}_{trans , k} {α}_{2 , k} [ i ] {γ}_{2 , k} [ i , j ] {β}_{2 , k + 1} [ j ] & ( 3.3 )\end{matrix}$$

In other words, for example, a second sampling can be used to obtain the sequence y₂[k], which can be described by, for example, equation (3.1) if the sampling is set appropriately. Based on the signal y₂[k], which may correspond to, for example, the second series 144 of samples or the second series 344 of samples, probabilities p[_{1,m}k] for symbols of the first signal portion may then be inferred by the probability determiner 160 using formulae (3.2) and (3.3) and using a summation of probabilities obtained by formula (3.3). For example, a BCJR algorithm can be used to obtain the probability values a_{2,k}i] and β_{2,k+1}[j] based on the values γ_{2,k}[i,j] obtained in equations (3.2).

However, alternative approaches are also possible.

7.3.2 Extension (or Modification) to Dual, Complexity-Reduced Processing without BCJR

The following describes a further variation of the procedure described above (e.g. in section 7.2) in accordance with an aspect of the present invention.

As an alternative to dual ISI utilization as described in section 7.3.1, the additional processing using (3.1) (or the second sampling providing a signal according to (3.1)) can be used to estimate the symbols of both signals iteratively as well, but without exploiting ISI memory, in order to save computational complexity. The saving in computational complexity negatively affects the power efficiency, which describes what signal-to-disturbance power ratio is used to achieve a certain symbol error rate. This loss of power efficiency decreases when the symbol phase difference is low and the carrier phase difference between signal 1 and 2 is favorable, so that there are situations where separation by exploiting ISI memory does not exhibit better a power efficiency—at higher computational complexity.

The estimation of the a-posteriori probabilities p_{1,m}[k] for signal 1, for example, follows the steps described in Section 7.2.4.2 according to (2.5)-(2.7). For the estimation of the a-posteriori probabilities p_{2,m}[k] for signal 2, the processing is carried out equivalently by means of y₂[k] from (3.1):

$${p}_{2 , m} [ k ] = {c}_{2 , sbs} {\sum }_{p = 0}^{{M}_{1}^{{L}_{dec} + 1} - 1} Pr \{ {i}_{2} [ k ] = {i}_{2 , p} \} {e}^{- \frac{{\vert {y}_{2} [ k ] - ( {v}_{2} {α}_{2 , m} + {i}_{2 , p} ) \vert}^{2}}{{v}_{3}^{2}}} \qquad ( 3.4 )$$

wherein the a-priori probabilities Pr{i₂[k]=i_{2,p}} are calculated, for example, from the product of the L_{dec}+1 a-posteriori probabilities p_{1,m}[k] which belong to i_{2,p}. If, for example, the interference value p=0 includes the symbol sequence

{α₁[k−L_{dec}/2]=α_{1,0};α₁[k−L_{dec}/2+1]=α_{1,0}; . . . α₁[k+L_{dec}/2]=α_{1,0}}, (3.5)

the value for Pr{i₂[k]=i_{2,0}} is calculated, for example, by

Pr{i₂[k]=i_{2,0}}=p_{1,0}[k−L_{dec}/2]·p_{1,0}[k−L_{dec}/2+1] . . . p_{1,0}[k+L_{dec}/2], (3.6)

Furthermore, c_{2,sbs} is selected so that the sum over all a-posteriori probabilities p_{2,m}[k] equals 1.

In other words, both in determining probabilities of transmission symbols of the first signal portion and in determining probabilities for transmission symbols of the second signal portion, a concept can thus be used in which probabilities of transmission symbols of the respective other signal portion are used to determine probabilities of various (disturbance) contributions (e.g. i_{1,p} and i_{2,p}). The probability of the different transmission symbols is then determined taking into account the (disturbance) contributions, wherein partial probabilities for the individual transmission symbols, which arise in the presence of certain (disturbance) contributions, are summed up over the different (disturbance) contributions (for example with index p).

However, modifications can also be made to the relevant concept.

7.3.3 Extension to Mutually Different Carrier Frequencies

Another idea of the present invention is to extend the mathematical model in equation (2.1), as well as the BCJR algorithm, to the separation of signals with two mutually different carrier frequencies f_{c,1} and f_{c,2}. These deviations are caused by movements of the transmitter or receiver, or by inaccuracies in the oscillator used in the transmitter.

Note: As a rule, the deviations of the carrier frequencies are many times smaller than the symbol rate. However, if the deviation is high in relation to the symbol rate, in some cases the same matched filter can no longer be applied for both processing paths or the system model should or must be adjusted accordingly.

In both preprocessing branches (from the first two expansions), the carrier frequencies of the ISI-affected components are synchronized to, i.e. the ECB transform takes place at the carrier frequency of the ISI component in each case, and the two equations (2.1) and (3.1) are adjusted as follows:

$$\begin{matrix}{y}_{1}^{′} [ k ] = {a}_{1} [ k ] {v}_{1} {e}^{j ( 2 π ( {f}_{c , 1} - {f}_{c , 2} ) ( kT + {T}_{1} ) ) + j ( {φ}_{1} - {φ}_{2} )} + {\sum }_{ {k}^{′} = - ∞}^{∞} {a}_{2} [ {k}^{′} ] {v}_{2} {g}_{0} ( ( k - {k}^{′} ) T + ( {T}_{1} - {T}_{2} ) ) + {v}_{3} {n}_{1}^{′} [ k ] and & ( 3.7 ) \\ {y}_{2}^{′} [ k ] = {a}_{2} [ k ] {v}_{2} {e}^{j ( 2 π ( {f}_{c , 2} - {f}_{c , 1} ) ( kT + {T}_{2} ) ) + j ( {φ}_{2} - {φ}_{1} )} + {\sum }_{ {k}^{′} = - ∞}^{∞} {a}_{1} [ {k}^{′} ] {v}_{1} {g}_{0} ( ( k - {k}^{′} ) T + ( {T}_{2} - {T}_{1} ) ) + {v}_{3} {n}_{2}^{′} [ k ] . & ( 3.8 )\end{matrix}$$

The ISI portion remains unchanged, only the ISI-free interference and the noise rotates, wherein the statistical properties of the latter are not changed due to its rotationally invariant properties. Thus, only the quantities α_{1,m} and α_{2,m} in equations (2.3) and (3.2) from the BCJR approach and in equations (2.5) and (3.4) from the reduced-complexity approach become time-varying, and only these must be replaced by

α_{1,m}[k]=α_{1,m}·e^{j(2π(f}^{_{c,1}}^{-f}^{_{c,2}}^{)(kT+T}^{₁}⁾) (3.9)

and

α_{2,m}[k]=α_{2,m}·e^{j(2π(f}^{_{c,2}}^{-f}^{_{c,1}}^{)(kT+T}^{₂}⁾) (3.10)

which increases the computational effort only comparatively marginally.

In other words, by slightly modifying the calculation rules or formulae used, the concepts described above can be extended to the presence of different carrier frequencies. However, the corresponding extensions are to be regarded as optional.

### 8. Conclusions

Aspects of the present invention are briefly summarized below.

A first aspect of the invention relates to an extension of the iterative separation method by means of BCJR algorithm to double preprocessing with a separate synchronization for both signals, where clock synchronization to the disturbance is performed and phase (and frequency) synchronization to the useful signal is performed, and the a-posteriori symbol probabilities of the signals are to be used as a-priori probabilities of the disturbance when applying BCJR for the other signal.

A second aspect of the invention relates to an extension to an iterative separation method without a BCJR algorithm with double preprocessing with separate synchronization for the two signals, wherein clock synchronization to the disturbance is performed and phase (and frequency) synchronization to the useful signal is performed, and the a-posteriori symbol probabilities of the signals are to be used as a-priori probabilities of the disturbance when applying the estimate for the other signal.

Another aspect of the invention relates to an extension of the iterative separation method by means of the BCJR algorithm and the iterative separation method without the BCJR algorithm to receiving two signals with mutually different carrier frequencies, wherein both methods are adjusted such that the phase of the clock-synchronized signal portion continues to rotate at each time step.

In this regard, it should be noted that the corresponding aspects of the invention may be used both individually and in combination with the embodiments described above.

In other words, an embodiment according to FIGS. 1, 2a and 2b, for example, may optionally be supplemented by all the aspects, features, functionalities and details described herein with respect to extending the iterative separation method by means of BCJR algorithm to double preprocessing with separate synchronization for both signals.

Furthermore, the embodiment according to FIGS. 3, 4a and 4b, for example, may optionally be supplemented by all the aspects, features, functionalities and details described herein with respect to extending to an iterative separation method without a BCJR algorithm with double preprocessing with separate synchronization for both signals.

Optionally, all embodiments may be supplemented by the features, functionalities and details described herein with respect to extending both iterative separation methods to receive two signals having mutually different carrier frequencies, for example.

Additionally, it should also be noted that the corresponding features, functionalities and details may be included in the corresponding embodiments both individually and in combination.

### 9. Implementation Alternatives

Although some aspects have been described in the context of a device, it is understood that these aspects also represent a description of the corresponding method such that a block or component of a device is also to be understood to be a corresponding method step or feature of a method step. In analogy, aspects described in the context of or as a method step also represent a description of a corresponding block or detail or feature of a corresponding device. Some or all of the method steps may be performed by (or using) a hardware apparatus, such as a microprocessor, a programmable computer, or an electronic circuit. In some embodiments, some or more of the key method steps may be performed by such an apparatus.

A signal encoded according to the invention, such as an audio signal or a video signal or a transport current signal, may be stored on a digital storage medium or may be transmitted on a transmission medium such as a wireless transmission medium or a wired transmission medium, for example the Internet.

The encoded audio signal according to the invention may be stored on a digital storage medium, or may be transmitted on a transmission medium, such as a wireless transmission medium or a wired transmission medium, such as the Internet.

Depending on particular implementation requirements, embodiments of the invention may be implemented in hardware or in software. The implementation may be performed using a digital storage medium, for example a floppy disk, a DVD, a Blu-ray disc, a CD, ROM, PROM, EPROM, EEPROM, or FLASH memory, a hard disk, or any other magnetic or optical storage medium having stored thereon electronically readable control signals which interact or as able to interact with a programmable computer system such that the respective method is performed. Therefore, the digital storage medium may be computer-readable.

Thus, some embodiments according to the invention include a data carrier having electronically readable control signals capable of interacting with a programmable computer system such that any of the methods described herein will be performed.

Generally, embodiments of the present invention may be implemented as a computer program product having program code, the program code being operative to perform any of the methods when the computer program product runs on a computer.

For example, the program code may also be stored on a machine-readable carrier.

Other embodiments include the computer program for performing any of the methods described herein, wherein the computer program is stored on a machine-readable carrier.

In other words, an embodiment of the method according to the invention is a computer program comprising program code for performing any of the methods described herein when the computer program runs on a computer.

Thus, another embodiment of the methods of the invention is a data carrier (or digital storage medium or computer-readable medium) on which the computer program for performing any of the methods described herein is recorded. The data carrier, digital storage medium or computer-readable medium is typically tangible and/or non-transitory or nonvolatile.

Thus, a further embodiment of the method according to the invention is a data stream or sequence of signals constituting the computer program for performing any of the methods described herein. The data stream or sequence of signals may, for example, be configured to be transferred via a data communication link, for example via the Internet.

Another embodiment comprises processing means, such as a computer or programmable logic device, configured or adapted to perform any of the methods described herein.

Another embodiment includes a computer having installed thereon the computer program for performing any of the methods described herein.

Another embodiment according to the invention comprises a device or system configured to transmit to a receiver a computer program for performing at least one of the methods described herein. The transmission may be, for example, electronic or optical. The receiver may be, for example, a computer, mobile device, storage device, or similar device. The device or system may include, for example, a file server for transmitting the computer program to the receiver.

In some embodiments, a programmable logic device (for example, a field programmable gate array, FPGA) may be used to perform some or all of the functionalities of the methods described herein. In some embodiments, a field programmable gate array may cooperate with a microprocessor to perform any of the methods described herein. Generally, in some embodiments, the methods are performed by any hardware device. This may be general-purpose hardware, such as a computer processor (CPU), or hardware specific to the method, such as an ASIC.

The devices described herein may be implemented using, for example, a hardware apparatus, or using a computer, or using a combination of a hardware apparatus and a computer.

The devices described herein, or any components of the devices described herein, may be implemented at least partly in hardware and/or in software (computer program).

For example, the methods described herein may be implemented using a hardware apparatus, or using a computer, or using a combination of a hardware apparatus and a computer.

The methods described herein, or any components of the methods described herein, may be performed at least partly by hardware and/or by software.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### BIBLIOGRAPHY

[1] Johannes Huber, Patent Application 102018202647.5 in Germany: Empfänger und Verfahren zum Empfangen eines Kombinationssignals unter Verwendung von Wahrscheinlichkeitsdichtefunktionen (Receiver and method for receiving a combination signal using probability density functions), February 2018.
[2] Johannes Huber, Patent Application 102018202649.1 in Germany: Empfänger und Verfahren zum Empfangen eines Kombinationssignals unter Verwendung getrennter Inphase-und Quadraturkomponenten (Receiver and method for receiving a combination signal using separate in-phase and quadrature components), February 2018.
[3] Johannes Huber, Patent application: Aufwandsgünstiger Empfänger für zwei überlagerte Datensignale (Two-User-Receiver) (Low-cost receiver for two superimposed data signals (two-user receiver)), November 2016

1. A receiver for receiving a combination signal comprising two separate signal portions whose pulses are shifted relative to each other and/or whose carrier waves comprise a phase difference,
wherein the receiver is configured to acquire a first series of samples using a first sampling, the first sampling being adjusted to a symbol phase of the first signal portion;
wherein the receiver is configured to acquire a second series of samples using a second sampling, the second sampling being adjusted to a symbol phase of the second signal portion;
wherein the receiver is configured to acquire probabilities of transmission symbols of the first signal portion and probabilities of transmission symbols of the second signal portion for a plurality of sampling times based on the first series of samples and the second series of samples;
wherein the receiver is configured to determine probabilities for symbols of the second signal portion based on samples of the first sampling and estimated or calculated probabilities for symbols of the first signal portion taking into account inter-symbol interference between transmission symbols of the second signal portion in the samples of the first sampling;
and
wherein the receiver is configured to determine probabilities for symbols of the first signal portion based on samples of the second sampling and estimated or calculated probabilities for symbols of the second signal portion taking into account inter-symbol interference between transmission symbols of the first signal portion in the samples of the second sampling.

2. The receiver according to claim 1,
wherein sampling times of the first sampling are set to sample an output signal of a signal-adjusted filter such that an output signal portion of the signal-adjusted filter which is based on the first signal portion is sampled substantially free of inter-symbol interference; and
wherein sampling times of the second sampling are set to sample an output signal of a signal-adjusted filter such that an output signal portion of the signal-adjusted filter which is based on the second signal portion is sampled substantially free of inter-symbol interference.

3. The receiver according to claim 1,
wherein the receiver is configured to adjust the first sampling to the symbol phase of the first signal portion and to the carrier phase of the second signal portion; and
wherein the receiver is configured to adjust the second sampling to the symbol phase of the second signal portion and to the carrier phase of the first signal portion.

4. The receiver according to claim 1,
wherein the receiver is configured to determine first branch transition probabilities between states of a first state model describing inter-symbol interference between transmission symbols of the second signal portion in the samples of the first sampiing, based on the samples of the first sampling and estimated or calculated probabilities for symbols of the first signal portion, and to determine probabilities for symbols of the second signal portion based on the first branch transition probabilities; and/or
wherein the receiver is configured to determine second branch transition probabilities between states of a second state model describing inter-symbol interference between transmission symbols of the first signal portion in the samples of the second sampling, based on the samples of the second sampling and estimated or calculated probabilities for symbols of the second signal portion, and to determine probabilities for symbols of the first signal portion based on the second branch transition probabilities.

5. The receiver according to claim 4,
wherein the receiver is configured to acquire the probabilities for symbols of the second signal portion using a first probability density function of a disturbance affecting detection of transmission symbols of the second signal portion, where the first probability density function takes into account
a probability of at least one transmission symbol of the first signal portion,
an expected contribution of at least one transmission symbol of the first signal portion to a sample of the first sampling, and
an expected contribution of inter-symbol interference between transmission symbols of the second signal portion.

6. The receiver according to claim 5, wherein the receiver is configured to take into account, in an evaluation of the first probability density function, a time-varying contribution of a transmission symbol of the first signal portion resulting from a difference in carrier frequencies of the first signal portion and the second signal portion.

7. The receiver according to claim 4,
wherein the receiver is configured to acquire the probabilities for symbols of the first signal portion using a second probability density function of a disturbance affecting detection of transmission symbols of the first signal portion, where the second probability density function takes into account
a probability of at least one transmission symbol of the second signal portion,
an expected contribution of at least one transmission symbol of the second signal portion to a sample of the second sampling, and
an expected contribution of inter-symbol interference between transmission symbols of the first signal portion.

8. The receiver according to claim 7, wherein the receiver is configured to take into account, in an evaluation of the second probability density function, a time-varying contribution of a transmission symbol of the second signal portion resulting from a difference in carrier frequencies of the first signal portion and the second signal portion.

9. The receiver according to claim 4,
wherein the receiver is configured to acquire first state transition probabilities based on the first branch transition probabilities, and to determine probabilities for symbols of the second signal portion using the first state transition probabilities; and/or
wherein the receiver is configured to acquire second state transition probabilities based on the second branch transition probabilities and to determine probabilities for symbols of the first signal portion using the second state transition probabilities.

10. The receiver according to claim 1,
wherein the receiver is configured to determine first branch transition probabilities based on a sum of probability contributions for different possible transmission symbols of the first signal portion,
wherein the probability contributions are weighted according to the estimated or calculated probabilities of the respective transmission symbols of the first signal portion and describe a probability that a predetermined transmission symbol of the second signal portion follows after a predetermined sequence of transmission symbols of the second signal portion, taking into account a current sample of the first sampling, an inter-symbol interference between transmission symbols of the second signal portion and a noise intensity; and/or
wherein the receiver is configured to determine second branch transition probabilities based on a sum of probability contributions for different possible transmission symbols of the second signal portion,
wherein the probability contributions are weighted according to the estimated or calculated probabilities of the respective transmission symbols of the second signal portion,
and describe a probability that a predetermined transmission symbol of the first signal portion follows after a predetermined sequence of transmission symbols of the first signal portion, taking into account a current sample of the second sampling, an inter-symbol interference between transmission symbols of the first signal portion and a noise intensity.

11. The receiver according to claim 10,
wherein the receiver is configured to estimate transmission symbols of the second transmission signal portion based on a selection of state transitions, wherein the receiver is configured to select the state transitions such that an overall transition probability which is based on the branch transition probabilities is maximized; and/or
wherein the receiver is configured to estimate transmission symbols of the first transmission signal portion based on a selection of state transitions, wherein the receiver is configured to select the state transitions such that an overall transition probability which is based on the branch transition probabilities is maximized.

12. The receiver according to claim 1,
wherein the receiver is configured to acquire first branch transition probabilities γ_{1,k}[i,j] according to
$${γ}_{1 , k} [ i , j ] = {\sum }_{m = 0}^{{M}_{1} - 1} {p}_{1 , m} [ k ] {e}^{- \frac{{\vert {y}_{1} [ k ] - ( {v}_{1} {α}_{1 , m} {e}^{j ( {φ}_{1} - {φ}_{2 )}} + {i}_{1 , p} ) \vert}^{2}}{{v}_{3}^{2}}}$$
wherein m is a control variable,
wherein M₁ is a number of constellation points of the first signal portion;
wherein p_{1,m}[k] are estimated or calculated probabilities of the respective transmission symbols of the first signal portion at a time step k;
wherein y₁[k] is a sample of the first sampling at a time step k;
wherein v₁ is a gain factor of the first signal portion;
wherein a_{1,m} is a transmission symbol of the first signal portion with transmission symbol index m, or
wherein a_{1,m} describes a contribution of a transmission symbol of the first signal portion with a transmission symbol index m to the sample y₁[k], which is a time-variable contribution a_{1,m}[k] in the case of a difference between a carrier frequency of the first signal portion and a carrier frequency of the second signal portion;
wherein φ₁-φ₂ describes a phase shift between transmission symbols of the first signal portion and transmission symbols of the second signal portion;
wherein i_{1,p} describes inter-symbol interference between transmission symbols of the second signal portion; and
wherein v₃ describes a noise intensity;
and/or
wherein the receiver is configured to acquire second branch transition probabilities γ_{2,k}[i,j] according to
$${γ}_{2 , k} [ i , j ] = {\sum }_{m = 0}^{{M}_{2} - 1} {p}_{2 , m} [ k ] {e}^{- \frac{{\vert {y}_{2} [ k ] - ( {v}_{2} {α}_{2 , m} {e}^{j ( {φ}_{2} - {φ}_{1 )}} + {i}_{2 , p} ) \vert}^{2}}{{v}_{3}^{2}}}$$
wherein m is a control variable,
wherein M₂ is a number of constellation points of the second signal portion;
wherein p_{2,m}[k] are estimated or calculated probabilities of the respective transmission symbols of the second signal portion at a time step k;
wherein y₂[k] is a sample of the second sampling at a time step k;
wherein v₂ is a gain factor of the second signal portion;
wherein a_{2,m} is a transmission symbol of the second signal portion with transmission symbol index m, or
wherein a_{2,m} describes a contribution of a transmission symbol of the first signal portion with a transmission symbol index m to the sample y₂[k], which is a time-variable contribution a_{2,m}[k] in the case of a difference between a carrier frequency of the first signal portion and a carrier frequency of the second signal portion;
wherein φ₂-φ₁ describes a phase shift between transmission symbols of the second signal portion and transmission symbols of the first signal portion;
wherein i_{2,p} describes inter-symbol interference between transmission symbols of the first signal portion; and
wherein v₃ describes a noise intensity.

13. The receiver according to claim 12,
wherein the receiver is configured to determine probabilities α_{1,k}[i] for a state i at a k-th time step based on the first branch transition probabilities γ_{1,k}[i,j] using forward recursion, and
to determine probabilities β_{1,k+1}[j] for a state j at a k+1-th time step based on the first branch transition probabilities γ_{1,k} [i,j] using backward recursion, and to determine first state transition probabilities p_{1,k}(i,j) based on the probabilities α_{1,k}[i] for a state i at a k-th time step and β_{1,k+1}[j] for a state j at a k+1-th time step and using the first branch transition probabilities γ_{1,k} [i,j], and
to acquire probabilities p_{2,m}[k] of transmission symbols of the second signal portion based on the first state transition probabilities p_{1,k}(i,j);
and/or
wherein the receiver is configured to determine probabilities α_{2,k}[i] for a state i at a k-th time step based on the second branch transition probabilities γ_{2,k}[i,j] using forward recursion, and
to determine probabilities β_{2,k+1}[j] for a state j at a k+1-th time step based on the second branch transition probabilities γ_{2,k}[i,j] using backward recursion, and
to determine second state transition probabilities p_{2,k}(i,j) based on the probabilities α_{2,k}[i] for a state i at a k-th time step and β_{2,k+1}[j] for a state j at a k+1-th time step and using the second branch transition probabilities γ_{2,k}[i,j], and
to acquire probabilities p_{1,m}[k] of transmission symbols of the first signal portion based on the second state transition probabilities.

14. The receiver according to claim 13,
wherein the receiver is configured to acquire the first state transition probabilities p_{1,k}(i,j) according to
p_{1,k}(i,j)=c_{trans,k}α_{1,k}[i]γ_{1,k}[i,j]β_{1,k+1} [j]
wherein c_{trans,k} is a normalization factor;
and/or
wherein the receiver is configured to acquire the second state transition probabilities p_{2,k}(i,j) according to
p_{2,k}(i,j)=c_{trans,k}α_{2,k}[i]γ_{2,k}[i,j]β_{2,k+1}[j]
wherein c_{trans,k} is a normalization factor.

15. The receiver according to claim 1,
wherein the receiver is configured to acquire probabilities of transmission symbols of the second signal portion for a plurality of sampling times based on the first series of samples, taking into account inter-symbol interference between transmission symbols of the second signal portion in the first series of samples by using a first instance of a BCJR method, and taking into account superpositions by transmission symbols of the first signal portion as disturbance; and
wherein the receiver is configured to acquire probabilities of transmission symbols of the first signal portion for a plurality of sampling times based on the second series of samples, taking into account inter-symbol interference between transmission symbols of the first signal portion in the second series of samples by using a second instance of a BCJR method, and taking into account superpositions by transmission symbols of the second signal portion as disturbance.

16. The receiver according to claim 1,
wherein the receiver is configured to determine transmission symbols underlying the first signal portion, or probabilities of transmission symbols underlying the first signal portion by means of a trellis decoding method or based on the algorithm according to Bahl, Cocke, Jelinek and Raviv (BCJR algorithm); and
wherein the receiver is configured to determine transmission symbols underlying the second signal portion, or probabilities of transmission symbols underlying the second signal portion by means of a trellis decoding method or based on the algorithm according to Bahl, Cocke, Jelinek and Raviv (BCJR algorithm).

17. A method for receiving a combination signal comprising two separate signal portions whose pulses are shifted relative to each other and/or whose carrier waves comprise a phase difference,
wherein the method comprises acquiring a first series of samples using a first sampling, the first sampling being adjusted to a symbol phase of the first signal portion;
wherein the method comprises acquiring a second series of samples using a second sampling, the second sampling being adjusted to a symbol phase of the second signal portion;
wherein the method comprises acquiring probabilities of transmission symbols of the first signal portion and probabilities of transmission symbols of the second signal portion for a plurality of sampling times based on the first series of samples and the second series of samples;
wherein probabilities for symbols of the second signal portion are determined based on samples of the first sampling and estimated or calculated probabilities for symbols of the first signal portion taking into account inter-symbol interference between transmission symbols of the second signal portion in the samples of the first sampling;
and
wherein probabilities for symbols of the first signal portion are determined based on samples of the second sampling and estimated or calculated probabilities for symbols of the second signal portion taking into account inter-symbol interference between transmission symbols of the first signal portion in the samples of the second sampling.

18. A receiver for receiving a combination signal comprising two separate signal portions whose pulses are shifted relative to each other and/or whose carrier waves comprise a phase difference,
wherein the receiver is configured to acquire a first series of samples using a first sampling, the first sampling being adjusted to a symbol phase of the first signal portion;
wherein the receiver is configured to acquire a second series of samples using a second sampling, the second sampling being adjusted to a symbol phase of the second signal portion;
wherein the receiver is configured to acquire probabilities of transmission symbols of the first signal portion and probabilities of transmission symbols of the second signal portion for a plurality of sampling times based on the first series of samples and the second series of samples;
wherein the receiver is configured to determine probabilities for symbols of the second signal portion based on samples of the first sampling and estimated or calculated probabilities for symbols of the first signal portion taking into account inter-symbol interference between transmission symbols of the second signal portion in the samples of the first sampling;
and
wherein the receiver is configured to determine probabilities for symbols of the first signal portion based on samples of the second sampling and estimated or calculated probabilities for symbols of the second signal portion taking into account inter-symbol interference between transmission symbols of the first signal portion in the samples of the second sampling wherein sampling times of the first sampling are set to sample an output signal of a signal-adjusted filter such that an output signal portion of the signal-adjusted filter which is based on the first signal portion is sampled substantially free of inter-symbol interference; and
wherein sampling times of the second sampling are set to sample an output signal of a signal-adjusted filter such that an output signal portion of the signal-adjusted filter which is based on the second signal portion is sampled substantially free of inter-symbol interference.

19. A receiver for receiving a combination signal comprising two separate signal portions whose pulses are shifted relative to each other and/or whose carrier waves comprise a phase difference,
wherein the receiver is configured to acquire a first series of samples using a first sampling, the first sampling being adjusted to a symbol phase of the first signal portion;
wherein the receiver is configured to acquire a second series of samples using a second sampling, the second sampling being adjusted to a symbol phase of the second signal portion;
wherein the receiver is configured to acquire probabilities of transmission symbols of the first signal portion and probabilities of transmission symbols of the second signal portion for a plurality of sampling times based on the first series of samples and the second series of samples;
wherein the receiver is configured to determine probabilities for symbols of the second signal portion based on samples of the first sampling and estimated or calculated probabilities for symbols of the first signal portion taking into account inter-symbol interference between transmission symbols of the second signal portion in the samples of the first sampling;
wherein the receiver is configured to determine probabilities for symbols of the first signal portion based on samples of the second sampling and estimated or calculated probabilities for symbols of the second signal portion taking into account inter-symbol interference between transmission symbols of the first signal portion in the samples of the second sampling
wherein the receiver is configured to acquire first branch transition probabilities γ_{1,k}[i,j] according to
$${γ}_{1 , k} [ i , j ] = {\sum }_{m = 0}^{{M}_{1} - 1} {p}_{1 , m} [ k ] {e}^{- \frac{{\vert {y}_{1} [ k ] - ( {v}_{1} {α}_{1 , m} {e}^{j ( {φ}_{1} - {φ}_{2 )}} + {i}_{1 , p} ) \vert}^{2}}{{v}_{3}^{2}}}$$
wherein m is a control variable,
wherein M₁ is a number of constellation points of the first signal portion;
wherein p_{1,m}[k] are estimated or calculated probabilities of the respective transmission symbols of the first signal portion at a time step k;
wherein y₁[k] is a sample of the first sampling at a time step k;
wherein v₁ is a gain factor of the first signal portion;
wherein a_{1,m} is a transmission symbol of the first signal portion with transmission symbol index m, or
wherein a_{1,m} describes a contribution of a transmission symbol of the first signal portion with a transmission symbol index m to the sample y₁[k], which is a time-variable contribution a_{1,m}[k] in the case of a difference between a carrier frequency of the first signal portion and a carrier frequency of the second signal portion;
wherein φ₁-φ₂ describes a phase shift between transmission symbols of the first signal portion and transmission symbols of the second signal portion;
wherein i_{1,p} describes inter-symbol interference between transmission symbols of the second signal portion; and
wherein v₃ describes a noise intensity;
and/or
wherein the receiver is configured to acquire second branch transition probabilities γ_{2,k} [i,j] according to
$${γ}_{2 , k} [ i , j ] = {\sum }_{m = 0}^{{M}_{2} - 1} {p}_{2 , m} [ k ] {e}^{- \frac{{\vert {y}_{2} [ k ] - ( {v}_{2} {α}_{2 , m} {e}^{j ( {φ}_{2} - {φ}_{1 )}} + {i}_{2 , p} ) \vert}^{2}}{{v}_{3}^{2}}}$$
wherein m is a control variable,
wherein M₂ is a number of constellation points of the second signal portion;
wherein p_{2,m}[k] are estimated or calculated probabilities of the respective transmission symbols of the second signal portion at a time step k;
wherein y₂[k] is a sample of the second sampling at a time step k;
wherein v₂ is a gain factor of the second signal portion;
wherein a_{2,m} is a transmission symbol of the second signal portion with transmission symbol index m, or
wherein a_{2,m} describes a contribution of a transmission symbol of the first signal portion with a transmission symbol index m to the sample y₂[k], which is a time-variable contribution a_{2,m}[k] in the case of a difference between a carrier frequency of the first signal portion and a carrier frequency of the second signal portion;
wherein φ₂-φ₁ describes a phase shift between transmission symbols of the second signal portion and transmission symbols of the first signal portion;
wherein i_{2,p} describes inter-symbol interference between transmission symbols of the first signal portion; and
wherein v₃ describes a noise intensity.

20. A non-transitory digital storage medium having stored thereon a computer program for performing a method for receiving a combination signal comprising two separate signal portions whose pulses are shifted relative to each other and/or whose carrier waves comprise a phase difference,
wherein the method comprises acquiring a first series of samples using a first sampling, the first sampling being adjusted to a symbol phase of the first signal portion;
wherein the method comprises acquiring a second series of samples using a second sampling, the second sampling being adjusted to a symbol phase of the second signal portion;
wherein the method comprises acquiring probabilities of transmission symbols of the first signal portion and probabilities of transmission symbols of the second signal portion for a plurality of sampling times based on the first series of samples and the second series of samples;
wherein probabilities for symbols of the second signal portion are determined based on samples of the first sampling and estimated or calculated probabilities for symbols of the first signal portion taking into account inter-symbol interference between transmission symbols of the second signal portion in the samples of the first sampling;
and
wherein probabilities for symbols of the first signal portion are determined based on samples of the second sampling and estimated or calculated probabilities for symbols of the second signal portion taking into account inter-symbol interference between transmission symbols of the first signal portion in the samples of the second sampling,
when said computer program is run by a computer.
